(19) United States
(12) Patent Application Publication
(10) Pub. No.: US 2026/0156537 A1
(43) Pub. Date: Jun. 4, 2026

(54) CPC CONFIGURATION METHOD AND APPARATUS, AND COMMUNICATION DEVICE

(71) Applicant: VIVO MOBILE COMMUNICATION CO., LTD., Dongguan (CN)

(72) Inventors: Wei BAO, Dongguan (CN); Xuanbing LIU, Dongguan (CN)

(73) Assignee: VIVO MOBILE COMMUNICATION CO., LTD., Dongguan (CN)

(21) Appl. No.: 19/458,654

(22) Filed: Jan. 23, 2026

Related U.S. Application Data
(63) Continuation of application No. PCT/CN2024/106680, filed on Jul. 22, 2024.

(30) Foreign Application Priority Data
Jul. 27, 2023 (CN) 202310933741.4

(51) Int. Cl. H04W 36/00; H04W 36/08

(52) U.S. Cl. CPC H04W 36/0055; H04W 36/08

(57) ABSTRACT

A Conditional Primary secondary cell Change (CPC) configuration method and apparatus, and a communication device are provided. The CPC configuration method includes: receiving, by a master node, first indication information sent by a first secondary node. The first secondary node is a secondary node corresponding to a first target candidate cell. The first target candidate cell is a target candidate cell for an N^{th} CPC of a terminal. N is a positive integer. The first indication information is used to indicate CPC-related information of an (N+1)^{th} CPC of the terminal when a serving primary secondary cell of the terminal is changed to the first target candidate cell. The CPC configuration method further includes sending, by the master node, a CPC configuration to the terminal based on the CPC-related information of the (N+1)^{th} CPC of the terminal.

### CROSS-REFERENCE TO RELATED APPLICATIONS

This application is a continuation of International Application No. PCT/CN2024/106680, filed on Jul. 22, 2024, which claims priority to Chinese Patent Application No. 202310933741.4 filed on Jul. 27, 2023. The entire contents of each of the above-referenced applications are expressly incorporated herein by reference.

### TECHNICAL FIELD

This application relates to the field of communication technologies, and specifically, to a CPC configuration method and apparatus, and a communication device.

### BACKGROUND

In the related art, after a terminal completes a Primary Secondary Cell (PSCell) change through a Conditional PSCell Change (CPC) process, the CPC configuration stored in the terminal is no longer applicable because the serving PSCell of the terminal has changed. Therefore, after completion of the PSCell change through the CPC procedure, the terminal needs to re-perform a CPC preparation procedure and a CPC configuration procedure. During the CPC configuration, a network provides a new CPC configuration to the terminal to support the next CPC procedure, resulting in relatively high signaling overheads for the CPC configuration.

### SUMMARY

Embodiments of this application provide a CPC configuration method and apparatus, and a communication device.

According to a first aspect, a CPC configuration method is provided, including:

A master node receives first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when the serving primary secondary cell of the terminal is changed to the first target candidate cell.

The master node sends a CPC configuration to the terminal based on the CPC-related information of the (N+1)^{th} CPC of the terminal.

According to a second aspect, a CPC configuration method is provided, including:

A first secondary node sends first indication information to a master node, where the first secondary node is a secondary node corresponding to a first target candidate cell, the first target candidate cell is a target candidate cell for an N^{th} CPC of a terminal, and N is a positive integer.

The first indication information is used to indicate CPC-related information of an (N+1)^{th} CPC of the terminal when a serving primary secondary cell of the terminal is changed to the first target candidate cell.

According to a third aspect, a CPC configuration method is provided, including:

A terminal receives a CPC configuration sent by a master node.

The terminal performs, when a serving primary secondary cell of the terminal matches a source cell for a CPC of the terminal included in the CPC configuration, evaluation on a CPC execution condition corresponding to the matched source cell.

According to a fourth aspect, a CPC configuration apparatus is provided. A master node includes the CPC configuration apparatus. The apparatus includes:
a first receiving module, configured to receive first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell; and
a first sending module, configured to send a CPC configuration to the terminal based on the CPC-related information of the (N+1)^{th} CPC of the terminal.

According to a fifth aspect, a CPC configuration apparatus is provided. A first secondary node includes the CPC configuration apparatus. The apparatus includes:

a first sending module, configured to send first indication information to a master node, where the first secondary node is a secondary node corresponding to a first target candidate cell, the first target candidate cell is a target candidate cell for an N^{th} CPC of a terminal, and N is a positive integer.

The first indication information is used to indicate CPC-related information of an (N+1)^{th} CPC of the terminal when a serving primary secondary cell of the terminal is changed to the first target candidate cell.

According to a sixth aspect, a CPC configuration apparatus is provided. A terminal includes the CPC configuration apparatus. The apparatus includes:
a first receiving module, configured to receive a CPC configuration sent by a master node; and
an execution module, configured to perform, when a serving primary secondary cell of the terminal matches a source cell for a CPC of the terminal included in the CPC configuration, evaluation on a CPC execution condition corresponding to the matched source cell.

According to a seventh aspect, a communication device is provided. The communication device includes a processor and a memory. The memory stores a program or an instruction executable on the processor. The program or the instruction, when executed by the processor, implements the steps of the method according to the first aspect or the second aspect or the third aspect.

According to an eighth aspect, a communication device is provided. The communication device is a master node, including a processor and a communication interface. The communication interface is configured to: receive first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell. The communication interface is further configured to send a CPC configuration to the terminal based on the CPC-related information of the (N+1)^{th} CPC of the terminal.

According to a ninth aspect, a communication device is provided. The communication device is a first secondary node, including a processor and a communication interface. The communication interface is configured to: send first indication information to a master node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell.

According to a tenth aspect, a communication device is provided. The communication device is a terminal, including a processor and a communication interface. The communication interface is configured to receive a CPC configuration sent by a master node. The processor is configured to, when the serving primary secondary cell of the terminal matches a source cell of the CPC of the terminal included in the CPC configuration, perform evaluation on a CPC execution condition corresponding to the matched source cell.

According to an eleventh aspect, a CPC configuration system is provided, including a master node, a first secondary node, and a terminal. The master node may be configured to perform the steps of the method according to the first aspect. The first secondary node may be configured to perform the steps of the method according to the second aspect. The terminal may be configured to perform the steps of the method according to the third aspect.

According to a twelfth aspect, a readable storage medium is provided. The readable storage medium stores a program or an instruction. The program or the instruction, when executed by a processor, implements the steps of the method according to the first aspect, or implements the steps of the method according to the second aspect, or implements the steps of the method according to the third aspect.

According to a thirteen aspect, a chip is provided. The chip includes a processor and a communication interface. The communication interface is coupled to the processor. The processor is configured to run a program or an instruction to implement the steps of the method according to the first aspect, or implement the method according to the second aspect, or implement the method according to the third aspect.

According to a fourteenth aspect, a computer program/program product is provided. The computer program/program product is stored in a storage medium. The computer program/program product is executed by at least one processor to implement the steps of the method according to the first aspect, or implement the steps of the method according to the second aspect, or implement the steps of the method according to the third aspect.

In embodiments of this application, the master node receives the first indication information sent by the first secondary node, the first secondary node is the secondary node corresponding to the first target candidate cell, the first target candidate cell is the target candidate cell for the N^{th} CPC of the terminal, N is a positive integer, and the first indication information is used to indicate the CPC-related information of the (N+1)^{th} CPC of the terminal when the serving primary secondary cell of the terminal is changed to the first target candidate cell. The master node sends the CPC configuration to the terminal based on the CPC-related information of the (N+1)^{th} CPC of the terminal. In this way, through the first secondary node corresponding to the first target candidate cell for the N^{th} CPC of the terminal, the CPC-related information of the (N+1)^{th} CPC of the terminal is fed back to the master node when the serving primary secondary cell of the terminal is changed to the first target candidate cell, so that the master node can be allowed to obtain the CPC-related information of the (N+1)^{th} CPC of the terminal during preparation for the N^{th} CPC of the terminal, then continue to prepare for the (N+1)^{th} CPC of the terminal, and then send the configurations of the N^{th} CPC and the (N+1)^{th} CPC to the terminal. Therefore, after performing the N^{th} CPC, the terminal does not need to perform the CPC configuration procedure again. In other words, the terminal may perform a subsequent CPC evaluation and a corresponding primary secondary cell change based on a configuration of a pre-configured (N+1)^{th} CPC, so that signaling overheads for the CPC configuration can be reduced, and a delay caused by an additional CPC configuration can be avoided.

### BRIEF DESCRIPTION OF THE DRAWINGS

FIG. 1 is a block diagram of an applicable wireless communication system according to an embodiment of this application.

FIG. 2 is a flowchart I of a CPC configuration method according to an embodiment of this application.

FIG. 3 is a flowchart II of a CPC configuration method according to an embodiment of this application.

FIG. 4 is a flowchart III of a CPC configuration method according to an embodiment of this application.

FIG. 5 is a flowchart IV of a CPC configuration method according to an embodiment of this application.

FIG. 6 is a flowchart V of a CPC configuration method according to an embodiment of this application.

FIG. 7 is a flowchart VI of a CPC configuration method according to an embodiment of this application.

FIG. 8 is a flowchart VII of a CPC configuration method according to an embodiment of this application.

FIG. 9 is a flowchart VIII of a CPC configuration method according to an embodiment of this application.

FIG. 10 is a flowchart IX of a CPC configuration method according to an embodiment of this application.

FIG. 11 is a flowchart X of a CPC configuration method according to an embodiment of this application.

FIG. 12 is a schematic structural diagram I of a CPC configuration apparatus according to an embodiment of this application.

FIG. 13 is a schematic structural diagram II of a CPC configuration apparatus according to an embodiment of this application.

FIG. 14 is a schematic structural diagram III of a CPC configuration apparatus according to an embodiment of this application.

FIG. 15 is a schematic structural diagram of a communication device according to an embodiment of this application.

FIG. 16 is a schematic structural diagram of a terminal according to an embodiment of this application.

FIG. 17 is a schematic structural diagram I of a network side device according to an embodiment of this application.

FIG. 18 is a schematic structural diagram II of a network side device according to an embodiment of this application.

### DETAILED DESCRIPTION

Technical solutions in embodiments of this application are clearly described below with reference to accompanying drawings in embodiments of this application. Apparently, the described embodiments are merely some rather than all embodiments of this application. All other embodiments obtained by a person of ordinary skill in the art based on embodiments of this application fall within the protection scope of this application.

Terms “first”, “second”, and the like in this application are used to distinguish between similar objects rather than describe a specific order or sequence. It should be understood that the terms used in this way may be transposed where appropriate, so that embodiments of this application can be implemented in a sequence other than those illustrated or described herein. In addition, objects defined by “first” and “second” are generally of the same class and do not limit a quantity of objects. For example, one or more first objects may be arranged. In addition, “or” in this application indicates at least one of connected objects. For example, “A or B” encompasses three solutions: solution I: A is included but B is not included; solution II: B is included but A is not included; and solution III: both A and B are included. The character “/” generally indicates an “or” relationship between a preceding associated object and a succeeding associated object.

A term “indication” in this application may be a direct indication (or an explicit indication) or an indirect indication (or an implicit indication). The direct instruction may be understood as that a sending party clearly informs a receiving party of information, an operation to be performed, or a request result in the sent instruction. The indirect indication may be understood as that the receiving party determines corresponding information based on an indication sent by the sending party, or makes a determination and determines, based on a determining result, an operation that needs to be performed or a request result.

It should be noted that the technology described in embodiments of this application may be applied to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Division Multiple Access (SC-FDMA) system, or another system. Terms “system” and “network” in embodiments of this application are usually interchangeably used, and the described technology may be used for both the system and the radio technology mentioned above, or may be used for another system and another radio technology. A New Radio (NR) system is described below as an example, and the term NR is used in most of the following description. Nevertheless, the technologies may also be applied to a system other than the NR system, such as a 6^{th} Generation (6G) communication system.

FIG. 1 is a block diagram of a wireless communication system to which embodiments of this application may be applied. The wireless communication system includes a terminal 11 and a network side device 12. The terminal 11 may be a terminal side device such as a mobile phone, a tablet computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR), a Virtual Reality (VR) device, a robot, a wearable device, a flight vehicle, an on-board device (Vehicle User Equipment (VUE)), a shipborne device, a pedestrian terminal (Pedestrian User Equipment (PUE)), a smart home appliance (a home device with a wireless communication capability, such as a refrigerator, a television, a washing machine, or furniture), a game console, a Personal Computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The on-board device may also be referred to as an on-board terminal, an on-board controller, an on-board module, an on-board component, an on-board chip, an on-board unit, or the like. Besides the foregoing terminal devices, a chip in a terminal may also be included, for example, a modem chip or a System on Chip (SoC). It should be noted that a specific type of the terminal 11 is not limited in embodiments of this application. The network side device 12 may include an access network device or a core network device. The access network device may also be referred to as a Radio Access Network (RAN) device, a wireless access network function, or a wireless access network unit. The access network device may include a base station, a Wireless Local Area Network (WLAN) Access Point (AS), a Wireless Fidelity (WiFi) node, or the like. The base station may be referred to as a Node B (NB), an Evolved Node B (eNB), a next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a home Node B (HNB), a home evolved Node B, a Transmission Reception Point (TRP), or another appropriate term in the art. The base station is not limited to a specific technical term, as long as the same technical effect can be achieved. It should be noted that, in this embodiment of this application, only a base station in an NR system is used as an example for description, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in embodiments of this application, only a core network device in the NR system is used as an example, and a specific type of the core network device is not limited.

For ease of understanding, some contents in embodiments of this application are described below.

### 1. Dual Connectivity (DC)

The dual connectivity means that a network (NW) provides resources of two network nodes/base stations (access network elements) for a User Equipment (UE, that is, a terminal), where one network node is referred to as a Master Node (MN), and the other is referred to as a Secondary Node (SN). Each network node may use one cell to provide services for the UE, and may also adopt the Carrier Aggregation (CA) technology, that is, configure, for the UE, a plurality of serving cells controlled by the node. One or more cells controlled by a node form a Cell Group (CG). The MN controls a Master Cell Group (MCG), and the SN controls a Secondary Cell Group (SCG). Each cell group includes a Special Cell (SpCell) and M Secondary Cells (Scells). In NR, a current value of M is in a range of [0, 31], and may be expanded subsequently. The special cell in the MCG is referred to as a Primary Cell (PCell), and the special cell in the SCG is referred to as a Primary Secondary Cell (PSCell).

In the NR, if the UE applies an SCG configuration including a synchronization reconfiguration indication (ReconfigurationWithSync IE) provided by the NW, the UE performs a PSCell change.

### 2. CPC Procedure

The NW pre-configures a CPC configuration for the dual-connectivity UE, and the UE evaluates whether an execution condition is satisfied. The CPC configuration includes the execution condition for the PSCell change and a configuration parameter of a target SCG (a cell group that includes the target PSCell). Once the execution condition is satisfied, the UE applies a configuration of a pre-configured target SCG to perform a PSCell change.

The CPC configuration includes the execution condition for the PSCell change; the configuration parameter of the target SCG; and a CPC configuration ID.

The execution condition for the PSCell change includes N measurement identifiers (Measurement ids). Each measurement identifier corresponds to a measurement event. When a measurement result of the UE for a candidate Cell A satisfies a preset condition, the UE triggers a measurement event. When measurement events corresponding to N Measurement ids included in an execution condition are all triggered, the UE initiates a PSCell Change procedure to change a serving PSCell to Cell A. In short, the CPC is triggered. In the NR, a value of N is 1 or 2.

Configuration parameter of the target SCG: It is a configuration parameter of the SCG that includes the PSCell and needs to be applied by the UE to change the serving PSCell to Cell A. In the NR, a reconfiguration parameter of the target SCG is carried by a Radio Resource Control (RRC) reconfiguration message that includes a synchronous reconfiguration indication (ReconfigurationWithSync IE). The configuration includes an identifier of the target PSCell, and part of the configuration may be provided through an incremental configuration (delta config) (that is, only providing parameters different from those of the serving SCG).

CPC configuration identifier (ID): It means that one execution condition and one sets of configuration parameters for the target SCG are combined for a CPC procedure of one candidate PSCell. If N candidate cells are provided, N execution conditions and N sets of configuration parameters for the target SCG may be configured to allow the UE to perform evaluations simultaneously. A final target PSCell is determined based on an evaluation result. One execution condition for a PSCell and one set of configuration parameters for the target SCG are associated through a CPC configuration identifier, that is, one execution condition and one set of configuration parameters for the target SCG associated with the same CPC configuration identifier are directed to one candidate PSCell.

A parameter in the NR is used as an example.

condReconfigId indicates a CPC configuration ID, condExecutionCond is used to configure an execution condition for a PSCell change, and condRRCReconfig is used to configure a configuration parameter of the target SCG. The three parameters correspond to one set of CPC configurations, and are used for conditional re-configuration/a conditional primary secondary cell change for a candidate PSCell.

Details are as follows:

| | |
|---|---|
| {CondReconfigToAddMod-r16 ::= | SEQUENCE { |
| condReconfigId-r16 | CondReconfigId-r16, |
| condExecutionCond-r16 | SEQUENCE(SIZE(1..2))OF MeasId OPTIONAL, |

Need M

| condRRCReconfig-r16 | | OCTET STRING (CONTAINING |
|---|---|---|
| RRCReconfiguration) | OPTIONAL, | -- Cond condReconfigAdd |

```
    ... ,
  }
  }
```

In a CPC configuration, an applied measurement id is notified to a UE through a measurement configuration parameter. The measurement configuration includes the following parameters:

Measurement Object (MO): It is a to-be-measured frequency.

Report configuration (ReportConfig): It includes a trigger condition of a measurement event, which indicates that a corresponding measurement event is triggered when signal quality of a target PSCell satisfies a preset condition (determined by a type of a measurement event and a threshold parameter). For example, when a Reference Signal Received Power (RSRP) of a candidate PSCell is 3 dB higher than an RSRP of a current serving PSCell and lasts for 100 ms, triggering occurs. Quality of a candidate cell being higher than that of the serving cell is an A3 event indicated in a reporting configuration, and 3 dB and 100 ms are threshold parameters indicated in the reporting configuration.

Measurement id (measId): It refers to a measurement identifier, used to associate an MO with an event trigger condition.

In the NR, the three (Measurement Object, ReportConfig, and measId) are associated in the following manner:

| | |
|---|---|
| MeasIdToAddMod ::= | SEQUENCE { |
| measId | MeasId, |
| measObjectId | MeasObjectId, |
| reportConfigId | ReportConfigId |
| } | |

In the related art, a process of the CPC procedure is as follows:

ADC UE receives and stores the measurement configuration and CPC configuration delivered by the NW, and initiates the CPC evaluation.

Once at least one execution trigger condition is satisfied, the UE performs a corresponding PSCell change procedure.

Once the UE successfully accesses a target PSCe: (a Random Access Channel (RACH) is successfully completed in the target PSCell), the E deletes all stored CPC configurations.

The following provides an example to help understand the CPC procedure in the related art:

(1) AUE receives measurement- and CPC-related configurations provided by the NW, including the following two sets of CPC configurations, as shown in Table 1:

TABLE 1

| | First set | Second set |
|---|---|---|
| CPC | ID is 1, and an associated execution | ID is 2, and an execution trigger |
| configuration | trigger condition: MeasId = 1 | condition: MeasId = 2 |
| | Configuration parameter of a target | Configuration parameter of the |
| | SCG: including the target PSCell | target SCG: including the target |
| | being Cell A, and the like | PSCell being Cell B, and the like |

Measurement configuration

| | | |
|---|---|---|
| MeasId | ID is 1, associated | ID is 2, associated |
| | Measurement object identifier | measureObjectId: 2 |
| | (measObjectId): 1 | reportConfigId:2 |
| | Report configuration identifier | |
| | (reportConfigId): 1 | |
| measObjectId | ID is 1, and a corresponding | ID is 2, and the corresponding |
| | frequency is F2 | frequency is F1 |
| reportConfigId | ID is 1, and a corresponding | ID is 2, and a corresponding |
| | measurement event and trigger | measurement event and trigger |
| | condition is that an RSRP of a target | condition is that the RSRP of the |
| | PSCell is 3 dB higher than an RSRP | target PSCell is 4 dB higher than the |
| | of a serving PSCell, which lasts for | RSRP of the serving PSCell, which |
| | 100 ms | lasts for 80 ms |

(2) The UE performs measurement and evaluation: based on the first set of configurations, the UE measures CellA on the F2 frequency; and based on the second set of configurations, the UE measures CellB on the F1 frequency.

(3) Once at least one execution trigger condition is satisfied, the UE performs a corresponding PSCell handover procedure.

It is assumed that the execution trigger condition associated with the CPC configuration ID of 1 is triggered first, that is, the UE measures that the RSRP of CellA operating on the F2 frequency is 3 dB higher than the RSRP of the serving PSCell, and lasts for 100 ms. In other words, the measurement result of the UE for CellA satisfies the CPC execution trigger condition, and then the UE applies the configuration parameters of the target SCG associated with the CPC configuration ID of 1, that is, applies the configuration of the SCG with CellA as the PSCell, and accesses the target PSCell (that is, CellA).

(4) Once the UE successfully accesses the CellA (the RACH is successfully completed in the target PCell/CellA), the UE deletes the saved CPC configurations, that is, the first set and second set of CPC configurations.

In some embodiments, the NW (such as the target serving base station) reconfigures a CPC parameter for the UE. The newly configured CPC parameter may be the same as or different from a deleted CPC parameter.

In the related art, after completion of the PSCell change through the CPC procedure, the terminal needs to re-perform the CPC preparation procedure and the CPC configuration procedure. During the CPC configuration, a network provides a new CPC configuration to the terminal to support the next CPC procedure, resulting in relatively high signaling overheads for the CPC configuration.

A CPC configuration method and apparatus and a communication device provided in embodiments of this application are described in detail below through some embodiments and application scenarios thereof with reference to the accompany drawings.

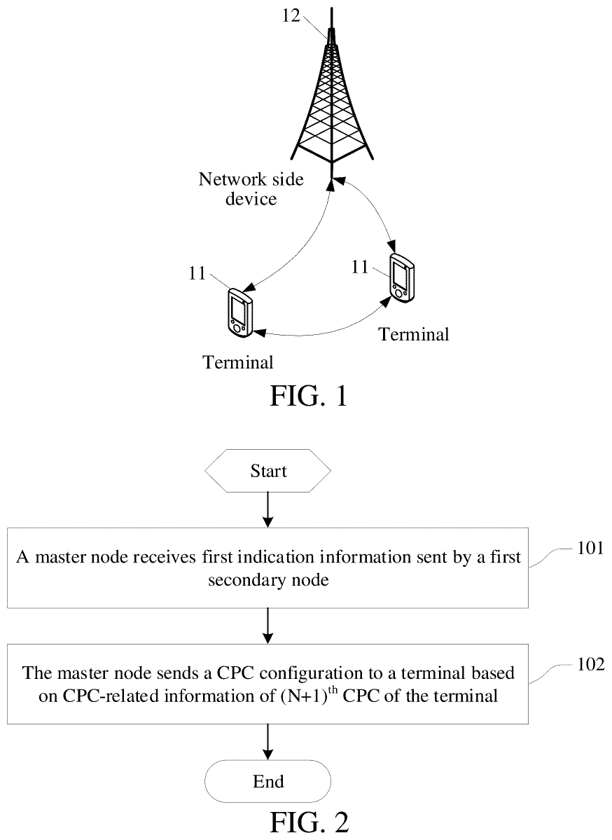

Refer to FIG. 2. FIG. 2 is a flowchart of a CPC configuration method according to an embodiment of this application. As shown in FIG. 2, the CPC configuration method includes the following steps.

Step 101: A master node receives first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when the serving primary secondary cell of the terminal is changed to the first target candidate cell.

The first indication information may be carried in a first message. The first message may be a message for CPC preparation. For example, the first message may be an SN addition confirmation message or an SN addition request message. The first message may further include configuration information of the first target candidate cell. The configuration information of the first target candidate cell is used by the terminal to change the serving primary secondary cell to the first target candidate cell.

The secondary node corresponding to the first target candidate cell may refer to a secondary node that administers or manages the first target candidate cell. That the first secondary node is a secondary node corresponding to the first target candidate cell may mean that the first target candidate cell is a cell administered or managed by the first secondary node.

The CPC-related information of the (N+1)^{th} CPC may include at least one of the following: an identifier of a second target candidate cell; and a CPC execution condition corresponding to the second target candidate cell, where the second target candidate cell is a target candidate cell for the (N+1)^{th} CPC of the terminal when the serving primary secondary cell of the terminal is changed to the first target candidate cell.

It should be noted that the target candidate cell may further be described as a candidate target cell, or a candidate cell, or a candidate primary secondary cell, or the like. The target candidate cell may be a candidate target cell for a CPC change.

It should be noted that when the secondary node corresponding to the second target candidate cell is the first secondary node, the first indication information may further be used to indicate CPC-related information of an (N+2)^{th} CPC of the terminal when the serving primary secondary cell of the terminal is changed to the second target candidate cell, and the second target candidate cell is the target candidate cell for the (N+1)^{th} CPC of the terminal when the serving primary secondary cell of the terminal is changed to the first target candidate cell.

When the secondary node corresponding to the second target candidate cell is the first secondary node, since the first secondary node is the secondary node corresponding to the first target candidate cell, the cell administered or managed by the first secondary node includes the first target candidate cell and the second target candidate cell.

It should be noted that the first secondary node is the secondary node corresponding to the first target candidate cell, and the first secondary node may further be a secondary node corresponding to a current serving primary secondary cell of the terminal.

Step 102: The master node sends a CPC configuration to the terminal based on the CPC-related information of the (N+1)^{th} CPC of the terminal.

The CPC configuration may include the CPC-related information of the (N+1)^{th} CPC of the terminal. In some alternative embodiments, the CPC configuration may include at least one of the following: an identifier of the target candidate cell for the (N+1)^{th} CPC, configuration information of the target candidate cell for the (N+1)^{th} CPC; an execution condition corresponding to the target candidate cell for the (N+1)^{th} CPC; or an identifier of a source cell for the (N+1)^{th} CPC. The master node may determine, based on the CPC-related information of the (N+1)^{th} CPC of the terminal, at least one of the identifier of the target candidate cell for the (N+1)^{th} CPC, the configuration information of the target candidate cell for the (N+1)^{th} CPC, the execution condition corresponding to the target candidate cell for the (N+1)^{th} CPC, or the identifier of the source cell for the (N+1)^{th} CPC.

It should be noted that in the related art, a CPC preparation procedure is as follows. A serving SN of a UE initiates handover preparation: the serving SN initiates a conditional SN change procedure: notifying the serving SN of a candidate PSCell and a CPC execution condition. An MN then determines configuration information of the candidate PSCell with the candidate PSCell. The MN obtains a combination of the CPC execution condition and the configuration information of the candidate PSCell, and sends the combination to the UE. The UE performs the CPC procedure.

In the related art, the CPC procedure does not support a subsequent CPC. In other words, after the UE completes one PSCell change based on the CPC procedure, the CPC configuration is no longer applicable. This is because a serving PSCell has changed. Therefore, after the PSCell changes, a new CPC configuration needs to be provided based on RRC signaling to support a subsequent CPC procedure. The CPC preparation procedure only supports a single CPC preparation, that is, the CPC configuration received by the UE is only associated with the serving PSCell at the time of receiving the configuration. Once a PSCell change occurs, a CPC configuration received by the UE before the PSCell change is no longer applicable. To perform the subsequent CPC, a network needs to perform a CPC reconfiguration, causing additional CPC configuration signaling overheads and a CPC evaluation delay. In this embodiment, in the CPC preparation procedure, CPC preparation is also completed for a potential serving PSCell, so that the CPC configuration of the UE may be used for N subsequent CPCs, where N>1.

It should be noted that the CPC preparation procedure is interaction between network-side base stations, and the CPC configuration is interaction between the NIN and the UE.

In this embodiment, in the subsequent CPC preparation procedure, in addition to feeding back the configuration of the target candidate cell specified by the NIN, the candidate SN further indicates to the MN the target candidate cell for a next CPC and the corresponding CPC execution condition when the target candidate cell serves as the serving PSCell.

In this embodiment, if A target candidate cells are prepared in the subsequent CPC preparation procedure, for each target candidate cell, the subsequent CPC target candidate cell and the corresponding CPC execution condition when the target candidate cell serves as the serving PSCell may be respectively indicated, where A≥1. Each target candidate cell serves as the serving PSCell, which may include B target candidate cells for the next CPC, where B>=0. If B=0, a CPC evaluation is not performed when the target candidate cell serves as the serving PSCell.

In embodiments of this application, the master node receives the first indication information sent by the first secondary node, the first secondary node is the secondary node corresponding to the first target candidate cell, the first target candidate cell is the target candidate cell for the N^{th} CPC of the terminal, N is a positive integer, and the first indication information is used to indicate the CPC-related information of the (N+1)^{th} CPC of the terminal when the serving primary secondary cell of the terminal is changed to the first target candidate cell. The master node sends the CPC configuration to the terminal based on the CPC-related information of the (N+1)^{th} CPC of the terminal. In this way, through the first secondary node corresponding to the first target candidate cell for the N^{th} CPC of the terminal, the CPC-related information of the (N+1)^{th} CPC of the terminal is fed back to the master node when the serving primary secondary cell of the terminal is changed to the first target candidate cell, so that the master node can be allowed to obtain the CPC-related information of the (N+1)^{th} CPC of the terminal during preparation for the N^{th} CPC of the terminal, then continue to prepare for the (N+1)^{th} CPC of the terminal, and then send the configurations of the N^{th} CPC and the (N+1)^{th} CPC to the terminal. Therefore, after performing the N^{th} CPC, the terminal does not need to perform the CPC configuration procedure again. In other words, the terminal may perform a subsequent CPC evaluation and a corresponding primary secondary cell change based on a configuration of a pre-configured (N+1)^{th} CPC, so that signaling overheads for the CPC configuration can be reduced, and a delay caused by an additional CPC configuration can be avoided.

In some embodiments, the CPC-related information of the (N+1)^{th} CPC includes at least one of the following:
an identifier of a second target candidate cell; or
a CPC execution condition corresponding to the second target candidate cell.

The second target candidate cell is a target candidate cell for the (N+1)^{th} CPC of the terminal when the serving primary secondary cell of the terminal is changed to the first target candidate cell.

The second target candidate cell may be a target candidate cell for the (N+1)^{th} CPC proposed by the first secondary node. When the serving primary secondary cell of the terminal is changed to the first target candidate cell, the terminal performs the (N+1)^{th} CPC to change the serving primary secondary cell of the terminal to the second target candidate cell if the terminal satisfies the CPC execution condition corresponding to the second target candidate cell.

It should be noted that one or more second target candidate cells may be arranged. The first indication information may be used to indicate the CPC execution condition corresponding to each of the second target candidate cells. When the terminal satisfies the CPC execution condition corresponding to one of the second target candidate cells, the terminal performs the (N+1)^{th} CPC to change the serving primary secondary cell of the terminal to the second target candidate cell satisfying the CPC execution condition.

In the implementation, the CPC-related information of the (N+1)^{th} CPC includes the identifier of the second target candidate cell, so that the master node can determine the target candidate cell for the (N+1)^{th} CPC of the terminal when the serving primary secondary cell of the terminal is changed to the first target candidate cell. After the terminal performs the N^{th} CPC, the network does not need to perform a preparation procedure for the (N+1)^{th} CPC of the terminal again to obtain the target candidate cell for the (N+1)^{th} CPC of the terminal, so that signaling overheads for the CPC preparation procedure and the CPC configuration procedure can be reduced. In some alternative embodiments, the CPC-related information of the (N+1)^{h} CPC includes the CPC execution condition corresponding to the second target candidate cell, so that the master node can be allowed to send the CPC execution condition of the target candidate cell for the (N+1)^{th} CPC of the terminal to the terminal as the CPC configuration. After performing the N^{th} CPC, the terminal does not need to perform the CPC configuration procedure again to configure the CPC execution condition of the target candidate cell for the (N+1)^{th} CPC of the terminal, so that the signaling overheads for the CPC configuration can be reduced.

In some embodiments, before the master node receives the first indication information sent by the first secondary node, the method includes:

The master node sends second indication information to the first secondary node, where the second indication information is used to indicate at least one of the following:
a subsequent CPC; or
an identifier of the first target candidate cell.

The second indication information may be carried in a second message. The second message may be a message for CPC preparation. For example, the second message may be an SN addition request message. The first target candidate cell may be the target candidate cell for the N^{th} CPC of the terminal proposed by the master node. One or more first target candidate cells may be arranged.

The second indication information may be used to indicate the subsequent CPC. For example, the second indication information may include a subsequent CPC indication or a subsequent CPC identifier. The subsequent CPC indication or the subsequent CPC identifier is used to indicate the subsequent CPC. The subsequent CPC indication or the subsequent CPC identifier may be used to instruct the secondary node to provide the master node with CPC-related information of the next CPC when the target candidate cell for a CPC serves as the serving primary secondary cell. For example, when the second indication information indicates the subsequent CPC, the second indication information is used to instruct the first secondary node to send the first indication information to the master node.

In an implementation, a third secondary node may send fifth indication information to the master node. The third secondary node is a secondary node corresponding to the serving primary secondary cell of the terminal. The fifth indication information is used to indicate at least one of the following: the subsequent CPC; or the identifier of the first target candidate cell. The master node sends the second indication information to the first secondary node based on the fifth indication information.

In an implementation, the master node may determine the first target candidate cell, and send the second indication information to the first secondary node. The second indication information is used to indicate at least one of the following: the subsequent CPC; or the identifier of the first target candidate cell. The master node may determine a first target candidate cell based on a current serving primary secondary cell of the terminal. For example, the master node may determine a neighboring cell of the current serving primary secondary cell of the terminal as the first target candidate cell. Therefore, the master node can determine a potential candidate cell for the subsequent CPC.

In the implementation, the master node sends the second indication information to the first secondary node. The second indication information is used to indicate at least one of the following: the subsequent CPC; or the identifier of the first target candidate cell. The master node receives the first indication information sent by the first secondary node. Therefore, the master node indicates the subsequent CPC to the first secondary node through the second indication information, so that the first secondary node provides the master node with the CPC-related information of the (N+1)^{th} CPC of the terminal for the subsequent CPC. In some alternative embodiments, the master node indicates the identifier of the first target candidate cell through the second indication information, so that the first secondary node feeds back, to the master node, the CPC-related information of the (N+1)^{th} CPC of the terminal when the serving primary secondary cell of the terminal is changed to the first target candidate cell.

In some embodiments, that the master node receives the first indication information sent by the first secondary node includes:

The master node receives the first indication information sent by the first secondary node when the second indication information indicates the subsequent CPC.

In an implementation, when the second indication information does not indicate the subsequent CPC, the master node receives the first message sent by the first secondary node. The first message does not carry the first indication information. The first message carries the configuration information of the first target candidate cell. For example, the first message may be an SN addition confirmation message.

In the implementation, when the second indication information indicates the subsequent CPC, the first secondary node feeds back the CPC-related information of the (N+1)^{th} CPC to the master node, thereby enabling, through whether the second indication information indicates the subsequent CPC, flexible control over whether the secondary node performs subsequent CPC preparation or non-subsequent CPC preparation.

In some embodiments, after the master node receives the first indication information sent by the first secondary node, the method further includes:

The master node sends third indication information to a second secondary node, where the second secondary node is a secondary node corresponding to the second target candidate cell, and the third indication information is used to indicate at least one of the following:
a subsequent CPC; or
the identifier of the second target candidate cell.

The third indication information may be carried in a third message. The third message may be a message for CPC preparation. For example, the third message may be an SN addition request message. The second target candidate cell may be the target candidate cell for the (N+1)^{th} CPC of the terminal proposed by the master node. One or more second target candidate cells may be arranged.

The secondary node corresponding to the second target candidate cell may refer to a secondary node that administers or manages the second target candidate cell. That the second secondary node is a secondary node corresponding to the second target candidate cell may mean that the second target candidate cell is a cell administered or managed by the second secondary node.

The third indication information may be used to indicate the subsequent CPC. For example, the third indication information may include a subsequent CPC indication or a subsequent CPC identifier. The subsequent CPC indication or the subsequent CPC identifier is used to indicate the subsequent CPC. The subsequent CPC indication or the subsequent CPC identifier may be used to instruct the secondary node to provide the master node with CPC-related information of the next CPC when the target candidate cell for a CPC serves as the serving primary secondary cell. For example, when the third indication information indicates the subsequent CPC, the third indication information is used to instruct the second secondary node to send fourth indication information to the master node. The fourth indication information is used to indicate the CPC-related information of the (N+2)^{th} CPC of the terminal when the serving primary secondary cell of the terminal is changed to the second target candidate cell.

In the implementation, the master node sends the third indication information to the second secondary node. The second secondary node is a secondary node corresponding to the second target candidate cell. The third indication information is used to indicate at least one of the following: a subsequent CPC; and an identifier of the second target candidate cell. Therefore, the master node indicates the subsequent CPC to the second secondary node through the third indication information, so that the second secondary node provides the master node with the CPC-related information of the (N+2)^{th} CPC of the terminal for the subsequent CPC. In some alternative embodiments, the master node indicates the identifier of the second target candidate cell through the third indication information, so that the second secondary node feeds back, to the master node, the CPC-related information of the (N+2)^{th} CPC of the terminal when the serving primary secondary cell of the terminal is changed to the second target candidate cell.

In some embodiments, after the master node sends the third indication information to the second secondary node, the method further includes:

The master node receives the fourth indication information sent by the second secondary node.

The fourth indication information is used to indicate the CPC-related information of the (N+2)^{th} CPC of the terminal when the serving primary secondary cell of the terminal is changed to the second target candidate cell.

That the master node sends the CPC configuration to the terminal based on the CPC-related information of the (N+1)^{th} CPC of the terminal includes:

The master node sends the CPC configuration to the terminal based on the CPC-related information of the (N+1)^{th} CPC of the terminal and the CPC-related information of the (N+2)^{th} CPC.

The fourth indication information may be carried in a fourth message. The fourth message may be a message for CPC preparation. For example, the fourth message may be an SN addition confirmation message. The fourth message may further include configuration information of the second target candidate cell. The configuration information of the second target candidate cell is used by the terminal to change the serving primary secondary cell to the second target candidate cell.

The CPC configuration may include the CPC-related information of the (N+1)^{th} CPC and CPC-related information of the (N+2)^{th} CPC of the terminal.

In the implementation, the master node receives the fourth indication information sent by the second secondary node. The fourth indication information is used to indicate the CPC-related information of the (N+2)^{th} CPC of the terminal when the serving primary secondary cell of the terminal is changed to the second target candidate cell. The master node sends the CPC configuration to the terminal based on the CPC-related information of the (N+1)^{th} CPC and the CPC-related information of the (N+2)^{th} CPC of the terminal. In this way, the master node can generate a CPC configuration for a subsequent CPC through CPC-related information of CPCs sent by the first secondary node and the second secondary node in a subsequent CPC preparation procedure, and send the CPC configuration for the subsequent CPC to the terminal at a time, so that signaling overheads for the CPC configuration can be reduced.

In some embodiments, the first indication information is further used to indicate CPC-related information of an (N+2)^{th} CPC of the terminal when the serving primary secondary cell of the terminal is changed to the second target candidate cell, and the second target candidate cell is the target candidate cell for the (N+1)^{th} CPC of the terminal when the serving primary secondary cell of the terminal is changed to the first target candidate cell.

That the master node sends the CPC configuration to the terminal based on the CPC-related information of the (N+1)^{th} CPC of the terminal includes:

The master node sends the CPC configuration to the terminal based on the CPC-related information of the (N+1)^{th} CPC of the terminal and the CPC-related information of the (N+2)^{th} CPC.

The CPC configuration may include the CPC-related information of the (N+1)^{th} CPC and CPC-related information of the (N+2)^{th} CPC of the terminal. The CPC-related information of the (N+2)^{th} CPC may include at least one of the following: an identifier of a third target candidate cell; and a CPC execution condition corresponding to the third target candidate cell, where the third target candidate cell is a target candidate cell for the (N+2)^{th} CPC of the terminal when the serving primary secondary cell of the terminal is changed to the second target candidate cell. A secondary node corresponding to the second target candidate cell is the first secondary node.

In the implementation, the master node sends the CPC configuration to the terminal based on the CPC-related information of the (N+1)^{th} CPC and the CPC-related information of the (N+2)^{th} CPC of the terminal, so that the master node can be allowed to generate CPC configurations for the subsequent CPC from the CPC-related information of the (N+1)^{th} CPC and the (N+2)^{th} CPC, and send the CPC configurations for the subsequent CPC to the terminal at a time, so that the signaling overheads for the CPC configurations can be reduced.

In some embodiments, the CPC-related information of the (N+2)^{th} CPC includes at least one of the following:
an identifier of a third target candidate cell; or
the CPC execution condition corresponding to the third target candidate cell.

The third target candidate cell is a target candidate cell for the (N+2)^{th} CPC of the terminal when the serving primary secondary cell of the terminal is changed to the second target candidate cell.

The third target candidate cell may be a target candidate cell for the (N+2)^{th} CPC proposed by the second secondary node. When the serving primary secondary cell of the terminal is changed to the second target candidate cell, the terminal performs the (N+2)^{th} CPC to change the serving primary secondary cell of the terminal to the third target candidate cell if the terminal satisfies the CPC execution condition corresponding to the third target candidate cell.

It should be noted that one or more third target candidate cells may be arranged. When the terminal satisfies the CPC execution condition corresponding to one of the third target candidate cells, the terminal performs the (N+2)^{th} CPC to change the serving primary secondary cell of the terminal to the third target candidate cell satisfying the CPC execution condition.

In the implementation, the CPC-related information of the (N+2)^{th} CPC includes the identifier of the third target candidate cell, so that the master node can determine the target candidate cell for the (N+2)^{th} CPC of the terminal when the serving primary secondary cell of the terminal is changed to the second target candidate cell. After the terminal performs the N^{th} CPC and the (N+1)^{th} CPC, the network does not need to perform a preparation procedure for the (N+2)^{th} CPC of the terminal again to obtain the target candidate cell for the (N+2)^{th} CPC of the terminal, so that signaling overheads for the CPC preparation procedure and the CPC configuration procedure can be further reduced. In some alternative embodiments, the CPC-related information of the (N+2)^{th} CPC includes the CPC execution condition corresponding to the third target candidate cell, so that the master node can be allowed to send the CPC execution condition of the target candidate cell for the (N+2)^{th} CPC of the terminal to the terminal as the CPC configuration. After performing the N^{th} CPC and the (N+1)^{th} CPC, the terminal does not need to perform the CPC configuration procedure again to configure the CPC execution condition of the target candidate cell for the (N+2)^{th} CPC of the terminal, so that the signaling overheads for the CPC configuration can be further reduced.

In some embodiments, when the first indication information is further used to indicate the CPC-related information of the (N+2)^{th} CPC, the secondary node corresponding to the second target candidate cell is the first secondary node.

In some embodiments, one or more first target candidate cells are arranged.

The CPC-related information of the (N+1)^{th} CPC includes the identifier of the second target candidate cell corresponding to each of the first target candidate cells; or the CPC-related information of the (N+1)^{th} CPC includes a CPC execution condition of the second target candidate cell corresponding to each first target candidate cell.

In some embodiments, before the master node sends the second indication information to the first secondary node, the method further includes:

The master node receives fifth indication information sent by a third secondary node, where the third secondary node is a secondary node corresponding to the serving primary secondary cell of the terminal; and
the fifth indication information is used to indicate at least one of the following:
a subsequent CPC; or
an identifier of the first target candidate cell.

The fifth indication information may be carried in a fifth message. The fifth message may be a message for CPC preparation. For example, the fifth message may be an SN change request message. The first target candidate cell may be the target candidate cell for the N^{th} CPC of the terminal proposed by the third secondary node to the master node. The fifth indication information may further be used to indicate a CPC execution condition corresponding to the first target candidate cell. When the terminal satisfies the CPC execution condition corresponding to the first target candidate cell, the terminal performs the N^{th} CPC to change the serving primary secondary cell of the terminal to the first target candidate cell.

The secondary node corresponding to the serving primary secondary cell of the terminal may refer to the secondary node of the serving primary secondary cell that currently administers or manages the terminal. The third secondary node is a secondary node corresponding to the serving primary secondary cell of the terminal, which may mean that the current serving primary secondary cell of the terminal is a cell administered or managed by the third secondary node.

The fifth indication information may be used to indicate the subsequent CPC. For example, the fifth indication information may include a subsequent CPC indication or a subsequent CPC identifier. The subsequent CPC indication or the subsequent CPC identifier is used to indicate the subsequent CPC. The subsequent CPC indication or the subsequent CPC identifier may be used to instruct the master node to perform the subsequent CPC preparation. For example, when the fifth indication information indicates the subsequent CPC, the fifth indication information may be used to instruct the master node to send the second indication information to the first secondary node to perform the subsequent CPC preparation.

It should be noted that one or more first target candidate cells may be arranged. The fifth indication information may further be used to indicate a CPC execution condition corresponding to each of the first target candidate cells. When the terminal satisfies the CPC execution condition corresponding to one of the first target candidate cells, the terminal performs the N^{th} CPC to change the serving primary secondary cell of the terminal to the first target candidate cell satisfying the CPC execution condition.

In an implementation, before the master node receives the fifth indication information sent by the third secondary node, the method may further include: The master node may determine a fourth target candidate cell and send sixth indication information to the third secondary node. The third secondary node is a secondary node corresponding to the fourth target candidate cell. The sixth indication information is used to indicate at least one of the following: an identifier of the fourth target candidate cell, or a subsequent CPC. In the implementation, the master node independently determines a proposed Conditional PSCell Addition (CPA) candidate cell and a corresponding CPA trigger condition, to implement a CPA procedure. In a single connection, when the terminal is not configured with a serving primary secondary cell, the master node independently determines which cell to be added as the serving primary secondary cell.

In this implementation, the master node receives the fifth indication information sent by the third secondary node. The third secondary node is a secondary node corresponding to the serving primary secondary cell of the terminal. The fifth indication information is used to indicate at least one of the following: a subsequent CPC; or an identifier of the first target candidate cell. The master node sends the second indication information to the first secondary node, so that the first secondary node sends the first indication information to the master node. Therefore, the master node can determine, through the subsequent CPC indicated by the fifth indication information, that this CPC preparation procedure is the subsequent CPC preparation procedure, and send the second indication information to the first secondary node to implement the subsequent CPC preparation procedure. In some alternative embodiments, the master node can determine the target candidate cell for the N^{th} CPC through an identifier of the first target candidate cell indicated by the fifth indication information, so as to send the second indication information to the first secondary node corresponding to the first target candidate cell for CPC preparation.

In some embodiments, the CPC configuration includes the CPC-related information of the (N+1)^{th} CPC of the terminal and a source cell for the (N+1)^{th} CPC of the terminal.

The CPC configuration may include a plurality of CPC sub-configurations. Each CPC sub-configuration includes CPC-related information of a CPC of the terminal and a source cell for the CPC of the terminal.

In an implementation, the plurality of CPC sub-configurations include at least a first CPC sub-configuration and a second CPC sub-configuration. The first CPC sub-configuration includes CPC-related information of an N^{th} CPC of the terminal and a source cell of the N^{th} CPC of the terminal. The CPC-related information of the N^{th} CPC of the terminal includes at least one of the following: the identifier of the first target candidate cell; and a CPC execution condition corresponding to the first target candidate cell. The second CPC sub-configuration includes the CPC-related information of the (N+1)^{th} CPC of the terminal and a source cell for the (N+1)^{th} CPC of the terminal.

In addition, the first CPC sub-configuration may further include configuration information of the first target candidate cell. The second CPC sub-configuration may further include configuration information of the second target candidate cell.

In an implementation, the plurality of CPC sub-configurations further include a third CPC sub-configuration. The third CPC sub-configuration includes the CPC-related information of the (N+2)^{th} CPC of the terminal and a source cell for the (N+2)^{th} CPC of the terminal. The third CPC sub-configuration may further include configuration information of the third target candidate cell.

It should be noted that each CPC sub-configuration among the plurality of CPC sub-configurations may further include an identifier of the CPC sub-configuration, for example, a number of the CPC sub-configuration.

In an implementation, the terminal receives the CPC configuration sent by the master node. When a serving primary secondary cell of the terminal matches a source cell for a CPC of the terminal included in the CPC configuration, the terminal performs evaluation on a CPC execution condition corresponding to the matched source cell. The matched source cell may refer to a source cell, among the source cells of the terminal included in the CPC configuration, which has the same cell identifier as the serving primary secondary cell of the terminal. The cell identifier may include a combined identifier of a frequency and a Physical Cell Identifier (PCI), that is, the cell identifiers are considered the same if both the frequency and the PCI are the same. In some alternative embodiments, the cell identifier may refer to a global cell identifier, and so on.

For example, the CPC configuration includes a plurality of CPC sub-configurations.

The plurality of CPC sub-configurations include a first CPC sub-configuration, a second CPC sub-configuration, and a third CPC sub-configuration. When the serving primary secondary cell of the terminal matches a source cell for a CPC in the first CPC sub-configuration, the terminal evaluates a CPC execution condition in the first CPC sub-configuration. When the serving primary secondary cell of the terminal matches a source cell for a CPC in the second CPC sub-configuration, the terminal evaluates a CPC execution condition in the second CPC sub-configuration. When the serving primary secondary cell of the terminal matches a source cell for a CPC in the third CPC sub-configuration, the terminal evaluates a CPC execution condition in the third CPC sub-configuration.

For example, after receiving a subsequent CPC configuration, the terminal applies the CPC configuration associated with the serving PSCell. For example, when the identifier of the source cell for the CPC is consistent with the identifier of the current serving PSCell of the terminal, the terminal evaluates a CPC execution condition associated with the identifier of the source cell for the CPC. Otherwise, the terminal does not evaluate the CPC execution condition associated with the identifier of the source cell for the CPC. In some alternative embodiments, after receiving the subsequent CPC configuration, the terminal does not apply a CPC configuration associated with a non-serving PSCell.

It should be noted that the terminal evaluates a CPC execution condition configured by a network. If an excessive quantity of CPC configurations are configured by the network, the terminal may have great evaluation workload. If the CPC configuration is used for N subsequent CPCs, the CPC execution conditions that the terminal needs to evaluate may exceed the capability of the terminal. In this embodiment, the terminal performs evaluation on the CPC execution condition corresponding to the matched source cell, thereby preventing the terminal from evaluating a large quantity of CPC execution conditions simultaneously.

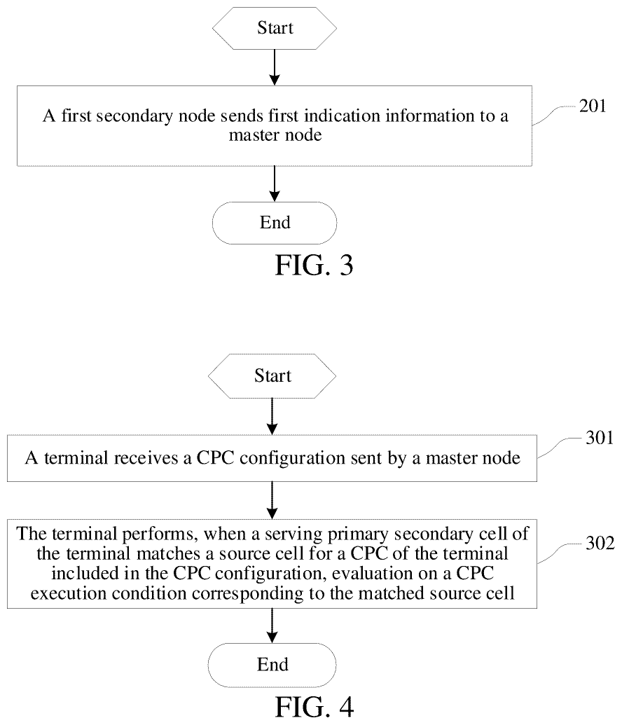

Refer to FIG. 3. FIG. 3 is a flowchart of a CPC configuration method according to an embodiment of this application. As shown in FIG. 3, the CPC configuration method includes the following steps.

Step 201: A first secondary node sends first indication information to a master node, where the first secondary node is a secondary node corresponding to a first target candidate cell, the first target candidate cell is a target candidate cell for an N^{th} CPC of a terminal, and N is a positive integer.

The first indication information is used to indicate CPC-related information of an (N+1)^{th} CPC of the terminal when a serving primary secondary cell of the terminal is changed to the first target candidate cell.

In some embodiments, the CPC-related information of the (N+1)^{th} CPC includes at least one of the following:
an identifier of a second target candidate cell; or
a CPC execution condition corresponding to the second target candidate cell.

The second target candidate cell is a target candidate cell for the (N+1)^{th} CPC of the terminal when the serving primary secondary cell of the terminal is changed to the first target candidate cell.

In some embodiments, before the first secondary node sends the first indication information to the master node, the method includes:

The first secondary node receives second indication information sent by the master node, where the second indication information is used to indicate at least one of the following:
a subsequent CPC; or
an identifier of the first target candidate cell.

In some embodiments, that a first secondary node sends first indication information to a master node includes:

The first secondary node sends the first indication information to the master node when the second indication information indicates the subsequent CPC.

In some embodiments, the first indication information is further used to indicate CPC-related information of an (N+2)^{th} CPC of the terminal when the serving primary secondary cell of the terminal is changed to the second target candidate cell.

The second target candidate cell is a target candidate cell for the (N+1)^{th} CPC of the terminal when the serving primary secondary cell of the terminal is changed to the first target candidate cell.

In some embodiments, the CPC-related information of the (N+2)^{th} CPC includes at least one of the following:
an identifier of a third target candidate cell; or
a CPC execution condition corresponding to the third target candidate cell.

The third target candidate cell is a target candidate cell for the (N+2)^{th} CPC of the terminal when the serving primary secondary cell of the terminal is changed to the second target candidate cell, and a secondary node corresponding to the second target candidate cell is the first secondary node.

It should be noted that this embodiment serves as the corresponding implementation of the first secondary node in the embodiment shown in FIG. 2. For an implementation, reference may be made to the relevant description of the embodiment shown in FIG. 2. To avoid repetition, details are not described again in this embodiment.

Refer to FIG. 4. FIG. 4 is a flowchart of a CPC configuration method according to an embodiment of this application. As shown in FIG. 4, the CPC configuration method includes the following steps.

Step 301: A terminal receives a CPC configuration sent by a master node.

Step 302: The terminal performs, when a serving primary secondary cell of the terminal matches a source cell for a CPC of the terminal included in the CPC configuration, evaluation on a CPC execution condition corresponding to the matched source cell.

In some embodiments, the CPC configuration includes CPC-related information of an (N+1)^{th} CPC of the terminal. The CPC-related information of the (N+1)^{th} CPC includes at least one of the following:
an identifier of a second target candidate cell; or
a CPC execution condition corresponding to the second target candidate cell.

The second target candidate cell is a target candidate cell for the (N+1)^{th} CPC of the terminal when a serving primary secondary cell of the terminal is changed to a first target candidate cell, and the first target candidate cell is a target candidate cell for an N^{th} of the terminal, where N is a positive integer.

In addition, the first target candidate cell may be a serving primary secondary cell after the N^{th} CPC of the terminal.

It should be noted that this embodiment serves as the corresponding implementation of the terminal in the embodiment shown in FIG. 2 and FIG. 3. For an implementation, reference may be made to the relevant description of the embodiment shown in FIG. 2. To avoid repetition, details are not described again in this embodiment.

An embodiment of this application further provides a CPC configuration method, including:

A second secondary node sends fourth indication information to a master node.

The fourth indication information is used to indicate the CPC-related information of the (N+2)^{th} CPC of a terminal when the serving primary secondary cell of the terminal is changed to a second target candidate cell.

The second target candidate cell is a target candidate cell for the (N+1)^{th} CPC of the terminal when a serving primary secondary cell of the terminal is changed to a first target candidate cell. The second secondary node is a secondary node corresponding to the second target candidate cell. The first target candidate cell is used for an N^{th} CPC of the terminal.

In some embodiments, before the second secondary node sends the fourth indication information to the master node, the method further includes:

The second secondary node receives third indication information sent by the master node, where the third indication information is used to indicate at least one of the following:
a subsequent CPC; or
the second target candidate cell.

In some embodiments, the CPC-related information of the (N+2)^{th} CPC includes at least one of the following:
an identifier of a third target candidate cell; or
a CPC execution condition corresponding to the third target candidate cell.

The third target candidate cell is a target candidate cell for the (N+2)^{th} CPC of the terminal when the serving primary secondary cell of the terminal is changed to the second target candidate cell.

An embodiment of this application further provides a CPC configuration method, including:

A master node receives an SN change request message sent by a third secondary node.

The master node generates a CPC configuration based on the SN change request message.

The SN change request message includes an identifier of a CPC candidate cell proposed by the third secondary node, and an execution condition corresponding to the proposed CPC candidate cell.

The CPC configuration includes at least one of the following:
an identifier of the proposed CPC candidate cell;
an execution condition corresponding to the proposed CPC candidate cell;
configuration information of the proposed CPC candidate cell; or
an identifier of a source cell for a CPC.

An embodiment of this application further provides a CPC configuration method, including:

A master node receives fifth indication information sent by a third secondary node. The third secondary node is a secondary node corresponding to a fourth target candidate cell. The fourth target candidate cell is a target candidate cell for a conditional primary secondary cell addition CPA of a terminal. The fifth indication information is used to indicate CPC-related information of a CPC of the terminal when the fourth target candidate cell is added as a serving primary secondary cell of the terminal.

The master node sends a CPC configuration to the terminal based on the CPC-related information of the CPC of the terminal.

The fifth indication information may be used to indicate CPC-related information of a first CPC of the terminal when the fourth target candidate cell is added as the serving primary secondary cell of the terminal. The fifth indication information may be carried in a fifth message. The fifth message may be a message for CPA. For example, the fifth message may be an SN addition confirmation message. The fifth message may further include configuration information of the fourth target candidate cell. The configuration information of the fourth target candidate cell is used by the terminal to add the fourth target candidate cell as the serving primary secondary cell. A secondary node corresponding to the fourth target candidate cell may refer to a secondary node that administers or manages the fourth target candidate cell. The CPC configuration may include the CPC-related information of the CPC of the terminal.

In the related art, after completing addition of a primary secondary cell through a CPA procedure, the terminal needs to perform a CPC preparation procedure. After the CPC preparation procedure, a network provides a CPC configuration to the terminal to support a first CPC procedure, resulting in high signaling overheads. In embodiments of this application, the CPC-related information of the CPC of the terminal indicated by the fifth indication information when the fourth target candidate cell is added as the serving primary secondary cell of the terminal can support the master node in obtaining the CPC-related information of the CPC of the terminal in the CPA procedure, and then continuing to prepare for the CPC of the terminal by sending the CPC configuration to the terminal. Therefore, after performing the CPA, the terminal may perform succeeding CPC evaluation and a corresponding primary secondary cell change based on a pre-configured CPC configuration, so that signaling overheads for a CPC preparation procedure and the CPC configuration can be reduced, and a delay caused by additional CPC preparation can be avoided.

In some embodiments, the CPC-related information of the CPC includes at least one of the following:
an identifier of a first target candidate cell; or
a CPC execution condition corresponding to the first target candidate cell.

The first target candidate cell is a candidate cell for the CPC of the terminal when the fourth target candidate cell is added as a serving primary secondary cell of the terminal.

In some embodiments, before the master node receives the fifth indication information sent by the third secondary node, the method further includes:

The master node determines the fourth target candidate cell, and sends sixth indication information to the third secondary node, where the sixth indication information is used to indicate at least one of the following:
an identifier of the fourth target candidate cell; or
a subsequent CPC.

The sixth indication information may be used to indicate the subsequent CPC. For example, the sixth indication information may include a subsequent CPC indication or a subsequent CPC identifier. The subsequent CPC indication or the subsequent CPC identifier is used to indicate the subsequent CPC. The subsequent CPC indication or the subsequent CPC identifier may be used to instruct the secondary node to provide the master node with CPC-related information of the next CPC when the target candidate cell for a CPC serves as the serving primary secondary cell. For example, when the sixth indication information indicates the subsequent CPC, the sixth indication information is used to instruct the third secondary node to send the fifth indication information to the master node.

In this embodiment, in a single connection, when the terminal is not configured with a serving primary secondary cell, the master node independently determines which cell to be added as the serving primary secondary cell. The master node independently determines a proposed CPA candidate cell, to implement a CPA procedure.

The CPC configuration method provided in embodiments of this application is described below through several embodiments.

### Embodiment 1

In the embodiment, a candidate SN feeds back an execution condition for a next CPC and a target cell identifier.

In this embodiment, a mapping relationship between a cell and an SN is as follows:

Cell1 is a cell administered by an S-SN (that is, a serving SN). When step (11) is performed, Cell1 is a serving PSCell of a UE.

Cell2 is a cell administered by a gNB1 (that is, a Candidate SN). When step (11) is performed, Cell2 is not a serving cell of the UE.

Cell3 is a cell administered by a gNB2 (that is, a Candidate SN). When step (11) is performed, Cell3 is not a serving cell of the UE.

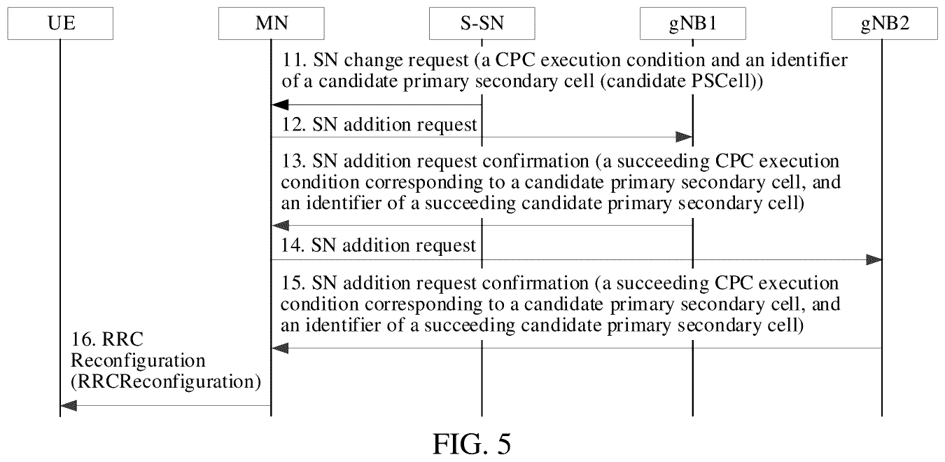

As shown in FIG. 5, the CPC configuration method includes the following process:

Step (11): An S-SN sends an SN change request message to an MN, where the request carries CPC-related information for configuration, including one or more pieces of the following information:
a list of CPC candidate cells proposed by the S-SN, such as an identifier of Cell2;
an execution condition for a corresponding CPC, where when the execution condition is satisfied, a UE performs a PSCell Change to change the serving PSCell from Cell1 to a cell in the list of the CPC candidate cells, such as Cell2; and
an identifier for a subsequent CPC, which indicates that this message is used for the subsequent CPC.

Step (12): The MN initiates, based on the received SN change request message, an SN addition request to a gNB (that is, a gNB1) to which Cell2 belongs, including one or more pieces of the following information:
an identifier for a subsequent CPC, which indicates that this message is used for the subsequent CPC; and
a list of proposed CPC candidate cells, such as an identifier of Cell2. The MN determines the list of proposed CPC candidate cells based on the list of CPC candidate cells proposed by the S-SN.

Step (13): The gNB1 sends an SN addition confirmation message to the MN, including one or more pieces of the following information:
a configuration corresponding to a CPC target candidate cell administered by the gNB1, that is, Cell2-related configuration information (if Cell2 may allow the UE to access), where the configuration is used when the UE changes the serving PSCell to Cell2;
an identifier of a succeeding CPC target candidate cell proposed by the gNB1: it is used to indicate, when Cell2 is the serving PSCell, an identifier of a target cell of the cell if the next CPC is performed, such as Cell3; and
a CPC execution condition corresponding to a change of the serving PSCell from Cell2 to Cell3.

Step (14): The MN initiates, based on the received SN addition confirmation message sent by the gNB1, an SN addition request to a gNB (that is, gNB2) where Cell3 is located, including one or more of the following:
an identifier for a subsequent CPC, which indicates that this message is used for the subsequent CPC; and
an identifier of a proposed CPC target candidate cell, that is, an identifier of Cell3.

Step (15): The gNB2 sends an SN addition confirmation message to the MN, including one or more pieces of the following information:
a configuration corresponding to a CPC target candidate cell on the gNB2, that is, Cell3-related configuration information (if Cell3 may allow the UE to access), where the configuration is used when the UE changes the serving PSCell to Cell3;
an identifier of a succeeding CPC target candidate cell proposed by the gNB2 when the SN change request message carries the identifier of the subsequent CPC: it is used to indicate, when Cell3 is the serving PSCell, an identifier of a target cell of the cell if the next CPC is performed, such as Cell2; and
a CPC execution condition corresponding to a change of the serving PSCell from Cell3 to Cell2 when the SN change request message carries the identifier of the subsequent CPC.

Step (16): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

For example, content included in the CPC configuration is shown in Table 2:

TABLE 2

| | | Identifier | |
|---|---|---|---|
| | | of a | Identifier of |
| | | source | a target |
| | | cell during | PSCell and/or |
| | | execution | configuration |
| | | of a | of the |
| Number | Execution condition | PSCell | target PSCell |
| 1 | An RSRP measurement value of a | Cell1 | Cell2 and/or |
| | target cell is 3 dB higher than an | | configuration |
| | RSRP measurement value of a | | of Cell2 |
| | source cell, and lasts for 200 ms | | |
| 2 | An RSRP measurement value of a | Cell2 | Cell3 and/or |
| | target cell is 2 dB higher than an | | configuration |
| | RSRP measurement value of a | | of Cell3 |
| | source cell, and lasts for 400 ms | | |
| 3 | An RSRP measurement value of a | Cell3 | Cell2 and/or |
| | target cell is 3 dB higher than an | | configuration |
| | RSRP measurement value of a | | of Cell2 |
| | source cell, and lasts for 400 ms | | |

It should be noted that a process formed by step (12) and step (13) may also be referred to as a subsequent CPC preparation procedure. Similarly, a process formed by step (14) and step (15) may also be referred to as a subsequent CPC preparation procedure.

In this embodiment (including a subsequent network side embodiment), if step (11) is not present, a CPA procedure is performed, and then the subsequent CPC procedure is performed. For example, in a single connection, when the UE is not configured with the SN, the MN determines which cell to be added as the SN. Step (12) in the CPA procedure is modified as:

The MIN initiates an SN addition request to a gNB (that is, a gNB1) to which Cell2 belongs, including one or more pieces of the following information:
an identifier for a subsequent CPC, which indicates that this message is used for the subsequent CPC; and
a list of proposed CPC candidate cells, such as an identifier of Cell2. The NIN independently determines the list of proposed CPA candidate cells and a corresponding CPA triggering condition.

Step (13) to step (16) remain unchanged.

### Embodiment 2

This embodiment describes processing after the UE receives the subsequent CPC configuration in step (16) of Embodiment 1.

Step (21): The UE receives and stores a subsequent CPC configuration.

Step (22): The UE evaluates some CPC execution conditions, which means that the UE evaluates only a CPC execution condition associated with a source cell having the same cell identifier as a current serving PSCell, as shown in Table 2.

Step (23): The UE determines, from the stored CPC configuration after the UE performs a PSCell change, a CPC execution condition that needs to be evaluated, which means that the UE evaluates only an execution condition associated with the source cell having the same cell identifier as the current serving PSCell.

The cell identifier may include a combination of a frequency and a PCI, or may refer to a global cell ID or the like.

### Embodiment 3

In the embodiment, a candidate SN feeds back an execution condition for a next CPC, an identifier of a target cell, and a configuration of the target cell.

In this embodiment, a mapping relationship between a cell and an SN is as follows:

Cell1 is a cell administered by an S-SN (a serving SN). When step (31) is performed, Cell1 is a serving PSCell of a UE.

Cell2 and Cell3 are cells administered by a gNB1 (a Candidate SN). When step (31) is performed, neither Cell2 nor Cell3 is a serving cell of the UE.

Step (31)/(32) is the same as step (11)/(12) in Embodiment 1. Step (34) is the same as step (16) in Embodiment 1.

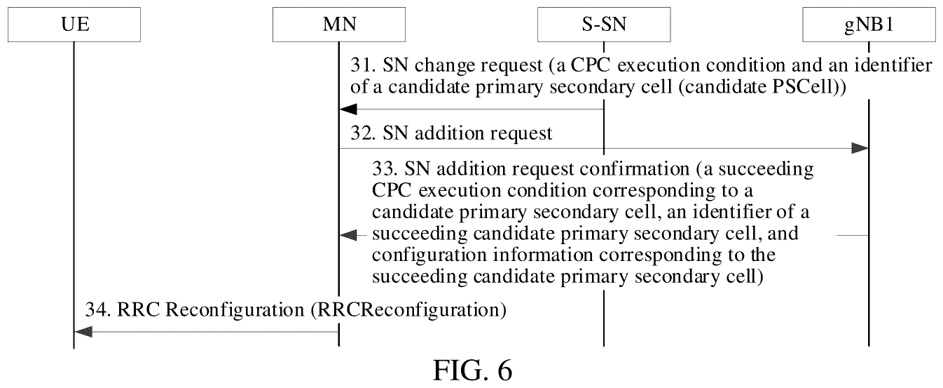

As shown in FIG. 6, the CPC configuration method includes the following process:

Step (31): An S-SN sends an SN change request message to an MN, where the request carries CPC-related information for configuration, including one or more pieces of the following information:
an identifier of a CPC target candidate cell (or a candidate PSCell) proposed by the S-SN, such as an identifier of Cell2; and
an execution condition for a corresponding CPC, where when the execution condition is satisfied, the UE executes a PSCell Change to change the serving PSCell from Cell1 to Cell2.

Step (32): The MN initiates, based on the received SN change request message, an SN addition request to a gNB (that is, a gNB1) to which Cell2 belongs, including one or more pieces of the following information:
an identifier for a subsequent CPC, which indicates that this message is used for the subsequent CPC; and
an identifier of a proposed CPC target candidate cell, that is, an identifier of Cell2.

Step (33): The gNB1 sends an SN addition confirmation message to the MN, including one or more pieces of the following information:
a configuration corresponding to the CPC target candidate cell proposed by the MN, that is, Cell2-related configuration information, where the configuration is used when the UE changes the serving PSCell to Cell2;
an identifier of a target candidate cell for a succeeding CPC proposed by the gNB1 when the SN change request message carries an identifier for a subsequent CPC: which is used to indicate, when Cell2 is the serving PSCell, an identifier of a target cell of the cell if the next CPC is performed, such as Cell3;
a CPC execution condition corresponding to a change of the serving PSCell from Cell2 to Cell3;
the configuration corresponding to the CPC target candidate cell provided by the gNB1, that is, Cell3-related configuration information, where the configuration is used when the UE changes the serving PSCell to Cell3; and since the candidate cell recommended by the gNB1 is a cell administered by this gNB, the gNB1 may directly provide the configuration corresponding to Cell3 as the serving PSCell;
an identifier of a target candidate cell for a succeeding CPC proposed by the gNB1: which is used to indicate, when Cell3 is the serving PSCell, an identifier of a target cell of the cell if the next CPC is performed, such as CellX; and
a CPC execution condition corresponding to a change of the serving PSCell from Cell3 to CellX.

CellX may be a cell administered by the gNB1 or a cell administered by another gNB.

Step (34): The MN generates a CPC configuration (including N sets of CPC configurations, where N>=1), and sends the CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

In this embodiment, the configuration returned by the CPC candidate SN to the MN includes the configuration of the target candidate cell for the subsequent CPC. The target candidate cell includes a target cell (such as a Cell 3) to be prepared that the MN does not indicate. The Cell 3 is a target candidate cell for a next CPC after a Cell 2 serves as a serving PSCell.

### Embodiment 4

In the embodiment, a serving SN sends an execution condition for a next CPC, an identifier of a target cell, and a configuration of the target cell.

In this embodiment, a mapping relationship between a cell and an SN is as follows:

Cell1 is a cell administered by an S-SN (a serving SN). When step (41) is performed, Cell1 is a serving PSCell of a UE.

Cell2 is another cell other than Cell1 administered by the S-SN. When step (41) is performed, Cell2 is not a serving PSCell of a UE.

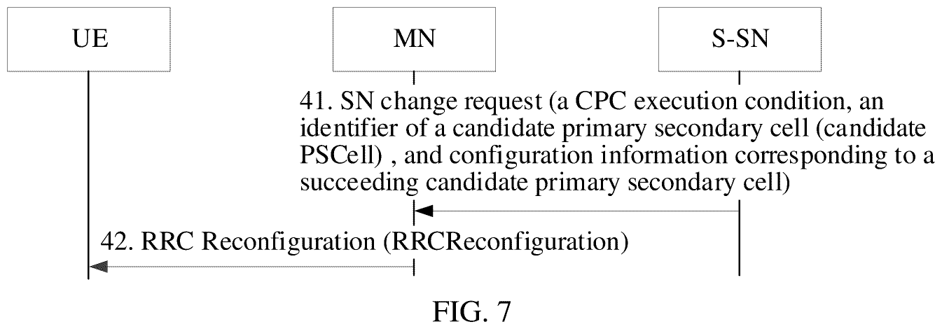

As shown in FIG. 7, the CPC configuration method includes the following process:

Step (41): An S-SN sends an SN change request message to an MN, where the request carries CPC-related information for configuration, including one or more pieces of the following information:
an identifier of a CPC candidate cell (or a candidate PSCell) proposed by the S-SN, such as an identifier of Cell2; and
an execution condition for a corresponding CPC, where when the execution condition is satisfied, the UE executes a PSCell Change to change the serving PSCell from Cell1 to Cell2; and
a configuration corresponding to a target candidate cell, that is, Cell2-related configuration information, where the configuration is used when the UE changes the serving PSCell to Cell2.

Step (42): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

For example, content included in the CPC configuration is shown in Table 3:

TABLE 3

| | | Identifier | |
|---|---|---|---|
| | | of a | Identifier of |
| | | source | a target |
| | | cell during | PSCell and/or |
| | | execution | configuration |
| | | of a | of the |
| Number | Execution condition | PSCell | target PSCell |
| 1 | An RSRP measurement value of a | Cell1 | Cell2 and/or |
| | target cell is 3 dB higher than an | | configuration |
| | RSRP measurement value of a | | of Cell2 |
| | source cell, and lasts for 200 ms | | |

### Embodiment 5

In the embodiment, a serving SN sends an execution condition for a next CPC, an identifier of a target cell, and a configuration of the target cell.

In this embodiment, a mapping relationship between a cell and an SN is as follows:

Cell1 is a cell administered by an S-SN (a serving SN). When step (51) is performed, Cell1 is a serving PSCell of a UE.

Cell2/3 is another cell other than Cell1 administered by the S-SN. When step (51) is performed, Cell2/3 is not a serving PSCell of a UE.

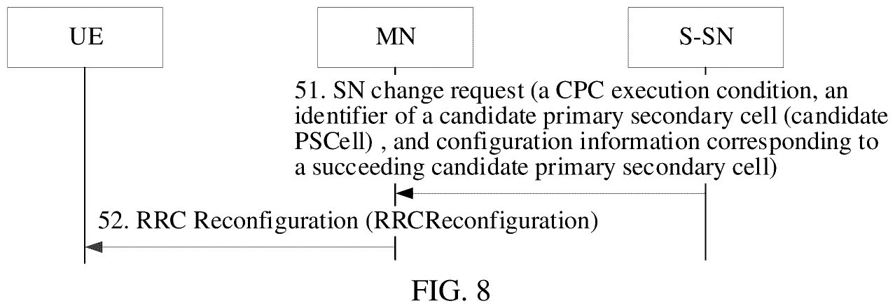

As shown in FIG. 8, the CPC configuration method includes the following process:

Step (51): An S-SN sends an SN change request message to an MN, where the request carries CPC-related information for configuration, including one or more pieces of the following information:
an identifier of a CPC candidate cell (or a candidate PSCell) proposed by the S-SN, such as an identifier of Cell2 or Cell3;
an identifier of a CPC source cell proposed by S-SN, such as Cell1, Cell2, and Cell3; a CPC execution condition;
a configuration corresponding to a target candidate cell, that is, Cell2/Cell3-related configuration information, where the configuration is used when the UE changes the serving PSCell to Cell2/Cell3.

The CPC execution condition includes:
an execution condition 1 for a CPC of a corresponding Cell2, where when the execution condition 1 is satisfied, the UE executes a PSCell Change to change the serving PSCell from Cell1 to Cell2;
an execution condition 2 for a CPC of a corresponding Cell3, where when the execution condition 2 is satisfied, the UE executes the PSCell Change to change the serving PSCell from Cell1 to Cell3;
an execution condition 3 for the CPC of the corresponding Cell2, where when the execution condition 3 is satisfied, the UE executes the PSCell Change to change the serving PSCell from Cell3 to Cell2; and
an execution condition 4 for the CPC of the corresponding Cell3, where when the execution condition 4 is satisfied, the UE executes a PSCell Change to change the serving PSCell from Cell2 to Cell3.

It should be noted that an SN may inform, through the message, the MN of an association relationship among a source cell, a candidate cell, and a corresponding CPC execution condition.

Step (52): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

For example, content included in the CPC configuration is shown in Table 3:

### Embodiment 6

In the embodiment, a candidate SN feeds back an execution condition for a next CPC and a target cell identifier.

In this embodiment, a mapping relationship between a cell and an SN is as follows:

Cell1 is a cell administered by an S-SN (a serving SN). When step (61) is performed, Cell1 is a serving PSCell of a UE.

Cell2, 3 are cells administered by the gNB1 (Candidate SN).

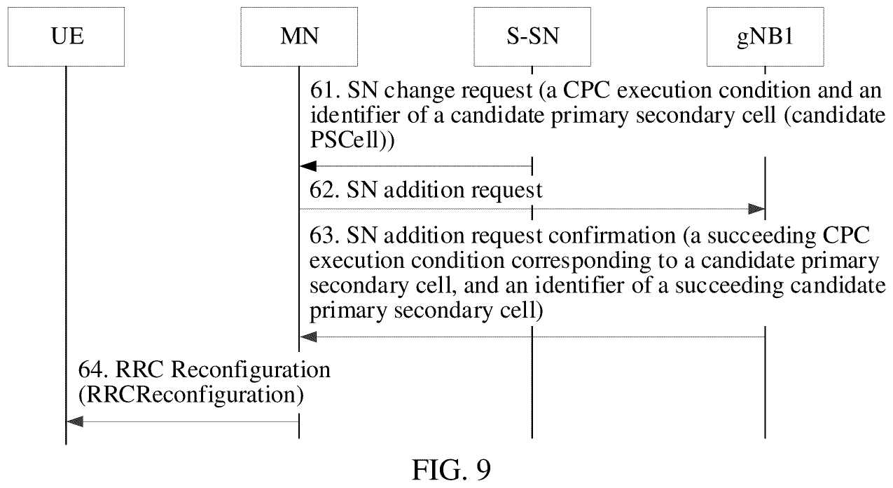

As shown in FIG. 9, the CPC configuration method includes the following process:

Step (61): An S-SN sends an SN change request message to an MN, where the request carries CPC-related information for configuration, including one or more pieces of the following information:
a list of CPC candidate cells proposed by the S-SN, such as an identifier of Cell2 and an identifier of Cell3;
an execution condition 1 for a corresponding CPC, where when the execution condition 1 is satisfied, a UE performs a PSCell Change to change the serving PSCell from Cell1 to a cell in the list of the CPC candidate cells, such as Cell2; and an execution condition 2 for a corresponding CPC, where when the execution condition 2 is satisfied, the UE executes the PSCell Change to change the serving PSCell from Cell1 to a cell in the list of the CPC candidate cells, such as Cell3; and
an identifier for a subsequent CPC, which indicates that this message is used for the subsequent CPC.

Step (62): The MN initiates, based on the received SN change request message, an SN addition request to a gNB (that is, a gNB1) to which Cell2 belongs, including one or more pieces of the following information:
an identifier for a subsequent CPC, which indicates that this message is used for the subsequent CPC; and
a list of proposed CPC candidate cells, such as identifiers of Cell2 and Cell3. The MN determines the list of proposed CPC candidate cells based on the list of CPC candidate cells proposed by the S-SN.

Step (63): The gNB1 sends an SN addition confirmation message to the MN, including one or more pieces of the following information:
a configuration corresponding to a CPC target candidate cell administered by the gNB1, that is, Cell2-related configuration information (if Cell2 may allow the UE to access) and/or Cell3-related configuration information (if Cell3 may allow the UE to access), where the configuration is used when the UE changes the serving PSCell to Cell2 or Cell3;
an identifier of a succeeding CPC target candidate cell proposed by the gNB1: it is used to indicate, when Cell2 is the serving PSCell, an identifier of a target cell of the cell if the next CPC is performed, such as Cell3; and/or indicate, when Cell3 is a serving PSCell, an identifier of a target cell of the cell if the next CPC is performed, such as Cell2;
a CPC execution condition corresponding to a change of the serving PSCell from Cell2 to Cell3; and/or a CPC execution condition corresponding to a change of the Serving PSCell from Cell3 to Cell2; and
a CPC execution condition corresponding to a change of the serving PSCell from Cell3 to Cell2; and/or a CPC execution condition corresponding to a change of the serving PSCell from Cell3 to Cell2.

Step (64): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

For example, content included in the CPC configuration is shown in Table 4:

TABLE 4

| | | Identifier | |
|---|---|---|---|
| | | of a | Identifier |
| | | source | of target |
| | | cell during | PSCell and/or |
| | | execution | configuration |
| | | of a | of target |
| Number | Execution condition | PSCell | PSCell |
| 1 | An RSRP measurement value of a | Cell1 | Cell2 and/or |
| | target cell is 3 dB higher than an | | configuration |
| | RSRP measurement value of a | | of Cell2 |
| | source cell, and lasts for 200 ms | | |
| 2 | An RSRP measurement value of a | Cell1 | Cell3 and/or |
| | target cell is 2 dB higher than an | | configuration |
| | RSRP measurement value of a | | of Cell3 |
| | source cell, and lasts for 400 ms | | |
| 3 | An RSRP measurement value of a | Cell2 | Cell3 and/or |
| | target cell is 3 dB higher than an | | configuration |
| | RSRP measurement value of a | | of Cell3 |
| | source cell, and lasts for 400 ms | | |
| 4 | An RSRP measurement value of a | Cell3 | Cell2 and/or |
| | target cell is 3 dB higher than an | | configuration |
| | RSRP measurement value of a | | of Cell2 |
| | source cell, and lasts for 400 ms | | |

### Embodiment 7

In the embodiment, when an SN initiates a subsequent CPC, an MN determines a potential candidate cell for the subsequent CPC.

In this embodiment, a mapping relationship between a cell and an SN is as follows:

Cell1 is a cell administered by an S-SN (a serving SN). When step (71) is performed, Cell1 is a serving PSCell of a UE.

Cell2 is a cell administered by a gNB1 (a Candidate SN). When step (71) is performed, Cell2 is not a serving cell of the UE.

Cell3 is a cell administered by a gNB2 (a Candidate SN). When step (71) is performed, Cell3 is not a serving cell of the UE.

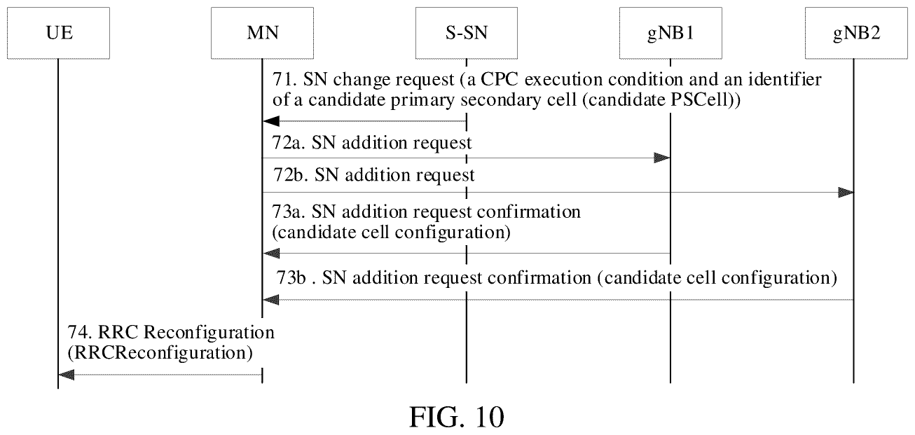

As shown in FIG. 10, the CPC configuration method includes the following process:

Step (71): An S-SN sends an SN change request message to an MN, where the request carries CPC-related information for configuration, including one or more pieces of the following information:
a list of CPC candidate cells proposed by the S-SN, such as an identifier of Cell2;
an execution condition for a corresponding CPC, where when the execution condition is satisfied, the UE executes a PSCell Change to change the serving PSCell from Cell1 to Cell2; and
an identifier for a subsequent CPC, which indicates that this message is used for the subsequent CPC.

Step (72a): The NIN initiates, based on the received SN change request message, an SN addition request to a gNB (that is, a gNB1) to which a potential candidate cell belongs, where the SN addition request includes one or more pieces of the following information:
an identifier for a subsequent CPC, which indicates that this message is used for the subsequent CPC; and
an identifier of a CPC target candidate cell proposed by the NIN, such as an identifier of Cell2.

Step (72b): The NIN independently determines a potential candidate cell Cell3 based on the received SN change request message, and initiates an SN addition request to the gNB (namely, a gNB2) to which the potential candidate cell belongs, where the SN addition request includes one or more pieces of the following information:
an identifier for a subsequent CPC, which indicates that this message is used for the subsequent CPC; and
an identifier of a CPC target candidate cell proposed by the NIN, such as an identifier of Cell2.

Step (73a): The gNB1 sends an SN addition confirmation message to the NIN, including one or more pieces of the following information:
a configuration corresponding to the CPC target candidate cell on the gNB1, such as Cell2-related configuration information, where the configuration is used when the UE changes the serving PSCell to Cell2; and
an identifier of the candidate cell as the succeeding CPC target candidate cell during conditional handover of the serving PSCell (used to indicate the identifier of the target cell, such as Cell3, if the next CPC is performed when Cell2 is the serving PSCell) and the corresponding CPC execution condition.

Similarly, step (73b): The gNB2 sends an SN addition confirmation message to the NIN, including one or more pieces of the following information:
a configuration corresponding to the CPC target candidate cell on the gNB2, such as Cell3-related configuration information, where the configuration is used when the UE changes the serving PSCell to Cell3;
an identifier of the candidate cell as the succeeding CPC target candidate cell during conditional handover of the serving PSCell (used to indicate the identifier of the target cell, such as Cell2, if the next CPC is performed when Cell3 is the serving PSCell) and the corresponding CPC execution condition.

Step (74): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

It should be noted that a difference between the embodiment and Embodiment 1 is that a process of obtaining CPC-related information of a next CPC changes from serial to parallel, so that the CPC preparation procedure is faster.

### Embodiment 8

Step (71) of Embodiment 7 may be omitted to obtain the embodiment.

In the embodiment, when an MN initiates a subsequent CPC, an MN determines a potential candidate cell for the subsequent CPC.

In this embodiment, a mapping relationship between a cell and an SN is as follows:

Cell1 is a cell administered by an S-SN (a serving SN). When step (81) is performed, Cell1 is a serving PSCell of a UE.

Cell2 is a cell administered by a gNB1 (a Candidate SN). When step (81) is performed, Cell2 is not a serving cell of the UE.

Cell3 is a cell administered by a gNB2 (a Candidate SN). When step (81) is performed, Cell3 is not a serving cell of the UE.

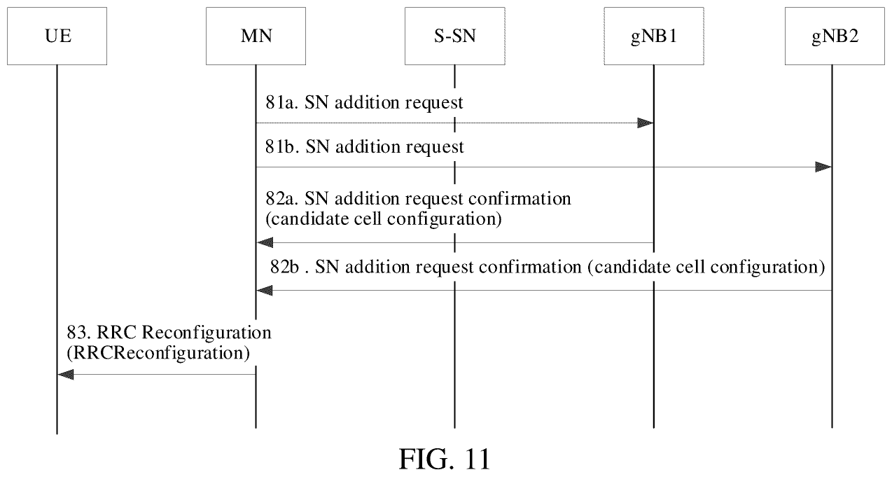

As shown in FIG. 11, the CPC configuration method includes the following process:

Step (81): The MN initiates an SN addition request to a gNB (that is, a gNB1 or a gNB2) to which a potential candidate cell belongs,
where the SN addition request includes one or more pieces of the following information:
an identifier for a subsequent CPC, which indicates that this message is used for the subsequent CPC; and
an identifier of a CPC target candidate cell proposed by the MN, such as an identifier of Cell2 and an identifier of Cell3.

Step (82): The gNB1/gNB2 sends an SN addition confirmation message to the NIN, including one or more pieces of the following information:
a configuration corresponding to the CPC target candidate cell on the gNB, such as Cell2/3-related configuration information, where the configuration is used when the UE changes the serving PSCell to Cell2/3; and
an identifier of the candidate cell as the succeeding CPC target candidate cell during conditional handover of the serving PSCell (used to indicate the identifier of the target cell, such as Cell3, if the next CPC is performed when Cell2 is the serving PSCell) and the corresponding CPC execution condition.

Step (83): The MN generates a CPC configuration (including N sets of CPC configurations, where N>=1), and the MN sends the generated CPC configuration to the UE. Each set of CPC configurations includes one or more pieces of the following information:
an identifier of a CPC configuration, such as a number;
a CPC execution condition;
an identifier of a target PSCell corresponding to the CPC execution condition and/or a configuration of the target PSCell; and
an identifier of a source cell for a CPC.

In this embodiment, the CPC condition for the UE to switch from Cell1 to Cell2/3 is generated by the MN.

The foregoing embodiments may be applicable to 5G and subsequent evolved communication systems.

In the foregoing embodiments, the CPC preparation procedure of the subsequent CPC is simplified, thereby preventing the UE from performing invalid CPC evaluation.

The CPC configuration method provided in embodiments of this application may be performed by a CPC configuration apparatus. In embodiments of this application, the CPC configuration apparatus provided in embodiments of this application is described by using an example in which the CPC configuration apparatus performs the CPC configuration method.

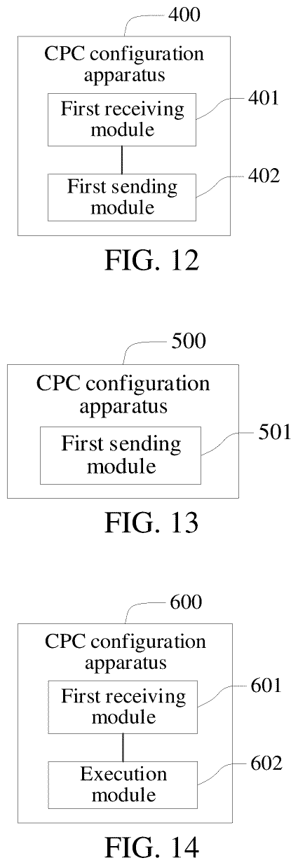

Refer to FIG. 12. FIG. 12 is a structural diagram of a CPC configuration apparatus according to an embodiment of this application. A master node includes the CPC configuration apparatus. As shown in FIG. 12, the CPC configuration apparatus 400 includes:
a first receiving module 401, configured to receive first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell; and
a first sending module 402, configured to send a CPC configuration to the terminal based on the CPC-related information of the (N+1)^{th} CPC of the terminal.

In some embodiments, the CPC-related information of the (N+1)^{th} CPC includes at least one of the following:
an identifier of a second target candidate cell; or
a CPC execution condition corresponding to the second target candidate cell, where
the second target candidate cell is a target candidate cell for the (N+1)^{th} CPC of the terminal when the serving primary secondary cell of the terminal is changed to the first target candidate cell.

In some embodiments, the apparatus further includes:
a second receiving module, configured to send second indication information to the first secondary node, where the second indication information is used to indicate at least one of the following:
a subsequent CPC; or
an identifier of the first target candidate cell.

In some embodiments, the first receiving module is further configured to:
receive the first indication information sent by the first secondary node when the second indication information indicates the subsequent CPC.

In some embodiments, the apparatus further includes:
a third sending module, configured to send third indication information to a second secondary node, where the second secondary node is a secondary node corresponding to the second target candidate cell, and the third indication information is used to indicate at least one of the following:
a subsequent CPC; or
the identifier of the second target candidate cell.

In some embodiments, the apparatus further includes:
a second receiving module, configured to receive the fourth indication information sent by the second secondary node.

The fourth indication information is used to indicate the CPC-related information of the (N+2)^{th} CPC of the terminal when the serving primary secondary cell of the terminal is changed to the second target candidate cell.

The first sending module is further configured to:
send the CPC configuration to the terminal based on the CPC-related information of the (N+1)^{th} CPC of the terminal and the CPC-related information of the (N+2)^{th} CPC.

In some embodiments, the first indication information is further used to indicate CPC-related information of an (N+2)^{th} CPC of the terminal when the serving primary secondary cell of the terminal is changed to the second target candidate cell, and the second target candidate cell is the target candidate cell for the (N+1)^{th} CPC of the terminal when the serving primary secondary cell of the terminal is changed to the first target candidate cell.

The first sending module is further configured to:
send the CPC configuration to the terminal based on the CPC-related information of the (N+1)^{th} CPC of the terminal and the CPC-related information of the (N+2)^{th} CPC.

In some embodiments, the CPC-related information of the (N+2)^{th} CPC includes at least one of the following:
an identifier of a third target candidate cell; or
a CPC execution condition corresponding to the third target candidate cell.

The third target candidate cell is a target candidate cell for the (N+2)^{th} CPC of the terminal when the serving primary secondary cell of the terminal is changed to the second target candidate cell.

In some embodiments, when the first indication information is further used to indicate the CPC-related information of the (N+2)^{th} CPC, the secondary node corresponding to the second target candidate cell is the first secondary node.

In some embodiments, one or more first target candidate cells are arranged.

The CPC-related information of the (N+1)^{th} CPC includes the identifier of the second target candidate cell corresponding to each of the first target candidate cells; or
the CPC-related information of the (N+1)^{th} CPC includes a CPC execution condition of the second target candidate cell corresponding to each first target candidate cell.

In some embodiments, the apparatus further includes:
a third receiving module, configured to receive fifth indication information sent by a third secondary node, where the third secondary node is a secondary node corresponding to the serving primary secondary cell of the terminal; and
the fifth indication information is used to indicate at least one of the following:
a subsequent CPC; or
an identifier of the first target candidate cell.

In some embodiments, the CPC configuration includes the CPC-related information of the (N+1)^{th} CPC of the terminal and a source cell for the (N+1)^{th} CPC of the terminal.

The CPC configuration apparatus in this embodiment of this application may be an electronic device, for example, an electronic device having an operating system, or may be a component in the electronic device, for example, an integrated circuit or a chip. The electronic device may be a terminal, or may be another device other than the terminal. For example, the terminal may include but is not limited to the above listed type of the terminal 11, and the another device may be a server, a Network Attached Storage (NAS), or the like. This is not limited in embodiments of this application.

The CPC configuration apparatus provided in embodiments of this application can implement the processes implemented in the method embodiment of FIG. 2, and achieve a same technical effect. To avoid repetition, details are not described herein again.

The CPC configuration method provided in embodiments of this application may be performed by a CPC configuration apparatus. In embodiments of this application, the CPC configuration apparatus provided in embodiments of this application is described by using an example in which the CPC configuration apparatus performs the CPC configuration method.

Refer to FIG. 13. FIG. 13 is a structural diagram of a CPC configuration apparatus according to an embodiment of this application. A first secondary node includes the CPC configuration apparatus. As shown in FIG. 13, the CPC configuration apparatus 500 includes: a sending module 501, configured to send first indication information to a master node, where the first secondary node is a secondary node corresponding to a first target candidate cell, the first target candidate cell is a target candidate cell for an N^{th} of a terminal, and N is a positive integer.

The first indication information is used to indicate CPC-related information of an (N+1)^{th} CPC of the terminal when a serving primary secondary cell of the terminal is changed to the first target candidate cell.

In some embodiments, the CPC-related information of the (N+1)^{th} CPC includes at least one of the following:
an identifier of a second target candidate cell; or
a CPC execution condition corresponding to the second target candidate cell, where
the second target candidate cell is a target candidate cell for the (N+1)^{th} CPC of the terminal when the serving primary secondary cell of the terminal is changed to the first target candidate cell.

In some embodiments, the apparatus further includes:
a receiving module, configured to receive second indication information sent by the master node, where the second indication information is used to indicate at least one of the following:
a subsequent CPC; or
an identifier of the first target candidate cell.

In some embodiments, the sending module is further configured to:
send the first indication information to the master node when the second indication information indicates the subsequent CPC.

In some embodiments, the first indication information is further used to indicate CPC-related information of an (N+2)^{th} CPC of the terminal when the serving primary secondary cell of the terminal is changed to the second target candidate cell.

The second target candidate cell is a target candidate cell for the (N+1)^{th} CPC of the terminal when the serving primary secondary cell of the terminal is changed to the first target candidate cell.

In some embodiments, the CPC-related information of the (N+2)^{th} CPC includes at least one of the following:
an identifier of a third target candidate cell; or
a CPC execution condition corresponding to the third target candidate cell.

The third target candidate cell is a target candidate cell for the (N+2)^{th} CPC of the terminal when the serving primary secondary cell of the terminal is changed to the second target candidate cell, and a secondary node corresponding to the second target candidate cell is the first secondary node.

The CPC configuration apparatus in this embodiment of this application may be an electronic device, for example, an electronic device having an operating system, or may be a component in the electronic device, for example, an integrated circuit or a chip. The electronic device may be a terminal, or may be another device other than the terminal. For example, the terminal may include but is not limited to the above listed type of the terminal 11, and the another device may be a server, an NAS, or the like. This is not limited in embodiments of this application.

The CPC configuration apparatus provided in embodiments of this application can implement the processes implemented in the method embodiment of FIG. 3, and achieve a same technical effect. To avoid repetition, details are not described herein again.

The CPC configuration method provided in embodiments of this application may be performed by a CPC configuration apparatus. In embodiments of this application, the CPC configuration apparatus provided in embodiments of this application is described by using an example in which the CPC configuration apparatus performs the CPC configuration method.

Refer to FIG. 14. FIG. 14 is a structural diagram of a CPC configuration apparatus according to an embodiment of this application. A terminal includes the CPC configuration apparatus. As shown in FIG. 14, the CPC configuration apparatus 600 includes:
a receiving module 601, configured to receive a CPC configuration sent by a master node; and
an execution module 602, configured to perform, when a serving primary secondary cell of the terminal matches a source cell for a CPC of the terminal included in the CPC configuration, evaluation on a CPC execution condition corresponding to the matched source cell.

In some embodiments, the CPC configuration includes CPC-related information of an (N+1)^{th} CPC of the terminal. The CPC-related information of the (N+1)^{th} CPC includes at least one of the following:
an identifier of a second target candidate cell; or
a CPC execution condition corresponding to the second target candidate cell.

The second target candidate cell is a target candidate cell for the (N+1)^{th} CPC of the terminal when a serving primary secondary cell of the terminal is changed to a first target candidate cell, and the first target candidate cell is a target candidate cell for an N^{th} CPC of the terminal, where N is a positive integer.

The CPC configuration apparatus in this embodiment of this application may be an electronic device, for example, an electronic device having an operating system, or may be a component in the electronic device, for example, an integrated circuit or a chip. The electronic device may be a terminal, or may be another device other than the terminal. For example, the terminal may include but is not limited to the above listed type of the terminal 11, and the another device may be a server, an NAS, or the like. This is not limited in embodiments of this application.

The CPC configuration apparatus provided in embodiments of this application can implement the processes implemented in the method embodiment of FIG. 4, and achieve a same technical effect. To avoid repetition, details are not described herein again.

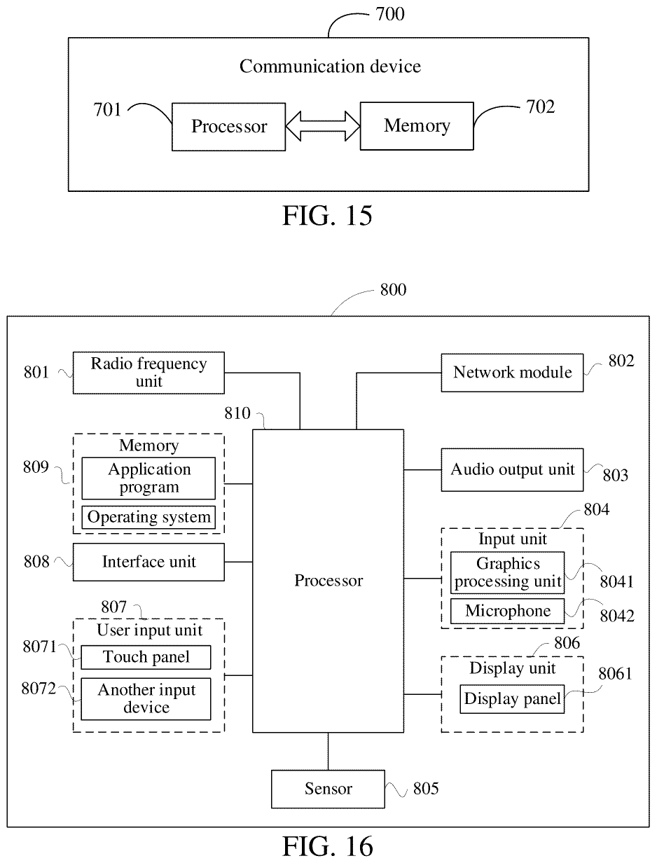

As shown in FIG. 15, an embodiment of this application further provides a communication device 700, including a processor 701 and a memory 702. The memory 702 stores a program or an instruction executable in the processor 701. For example, when the communication device 700 is a master node, the program or the instruction, when executed by the processor 701, implements the steps of the foregoing embodiments of the CPC configuration method applied to a master node, and can achieve the same technical effect. To avoid repetition, details are not described herein again. When the communication device 700 is a first secondary node, the program or the instruction, when executed by the processor 701, implements the steps in the foregoing embodiments of the CPC configuration method applied to the first secondary node, and can achieve the same technical effect. To avoid repetition, details are not described herein again. When the communication device 700 is a terminal, the program or the instruction, when executed by the processor 701, implements the steps in the foregoing embodiments of the CPC configuration method applied to the terminal, and can achieve the same technical effect. To avoid repetition, details are not described herein again.

An embodiment of this application further provides a communication device. The communication device is a master node, including a processor and a communication interface. The communication interface is configured to: receive first indication information sent by a first secondary node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell; and send a CPC configuration to the terminal based on the CPC-related information of the (N+1)^{th} CPC of the terminal.

An embodiment of this application further provides a communication device. The communication device is a first secondary node, including a processor and a communication interface. The communication interface is configured to: send first indication information to a master node, where the first secondary node is a secondary node corresponding to a first target candidate cell, the first target candidate cell is a target candidate cell for an N^{th} CPC of a terminal, N is a positive integer, and the first indication information is used to indicate CPC-related information of an (N+1)^{th} CPC of the terminal when a serving primary secondary cell of the terminal is changed to the first target candidate cell.

An embodiment of this application further provides a communication device. The communication device is a terminal, including a processor and a communication interface. The communication interface is configured to receive a CPC configuration sent by a master node. The processor is configured to perform, when the serving primary secondary cell of the terminal matches a source cell of the CPC of the terminal included in the CPC configuration, evaluation on a CPC execution condition corresponding to the matched source cell.

For example, FIG. 16 is a schematic diagram of a hardware structure of a terminal for implementing an embodiment of this application.

A terminal 800 includes but is not limited to at least some of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (for example, a battery) that supplies power to the components. The power supply may be logically connected to the processor 810 through a power management system, thereby implementing functions such as management of charging, discharging, and power consumption through the power management system. The terminal structure shown in FIG. 16 constitutes no limitation on the terminal, and the terminal may include more or fewer components than those shown in the figure, or some merged components, or different component arrangements. Details are not described herein again.

It should be noted that in embodiments of this application, the input unit 804 may include a Graphics Processing Unit (GPU) 8041 and a microphone 8042. The GPU 8041 processes image data of a static picture or a video obtained by an image capture apparatus (such as a camera) in a video capture mode or an image capture mode. The display unit 806 may include a display panel 8061. The display panel 8061 may be configured in a form such as a liquid crystal display or an organic light-emitting diode. The user input unit 807 includes at least one of a touch panel 8071 and another input device 8072. The touch panel 8071 is also referred to as a touch screen. The touch panel 8071 may include two parts: a touch detection apparatus and a touch controller. The another input device 8072 may include but is not limited to a physical keyboard, a function button (such as a volume control button or a power button), a trackball, a mouse, and a joystick. Details are not described herein again.

In this embodiment of this application, the radio frequency unit 801 receives downlink data from a network side device and may provide the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, an application or an instruction required for at least one function (such as a sound playback function and an image playback function), and the like. In addition, the memory 809 may include a volatile memory or a non-volatile memory, or the memory 809 may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 809 in embodiments of this application includes but is not limited to these and any other suitable types of memories.

The processor 810 may include one or more processing units. In some embodiments, the processor 810 integrates an application processor and a modem processor. The application processor mainly processes operations related to an operating system, a user interface, an application program, and the like. The modem processor mainly processes wireless communication signals, and is, for example, a baseband processor. It may be understood that the foregoing modem processor may not be integrated into the processor 810.

The radio frequency unit 801 is configured to receive a CPC configuration sent by a master node.

The processor 810 is configured to, when the serving primary secondary cell of the terminal matches a source cell of the CPC of the terminal included in the CPC configuration, perform evaluation on a CPC execution condition corresponding to the matched source cell.

In some embodiments, the CPC configuration includes CPC-related information of an (N+1)^{th} CPC of the terminal. The CPC-related information of the (N+1)^{th} CPC includes at least one of the following:
an identifier of a second target candidate cell; or
a CPC execution condition corresponding to the second target candidate cell.

The second target candidate cell is a target candidate cell for the (N+1)^{th} CPC of the terminal when a serving primary secondary cell of the terminal is changed to a first target candidate cell, and the first target candidate cell is a target candidate cell for an N^{th} CPC of the terminal, where N is a positive integer.

It may be understood that the implementation process of each implementation mentioned in this embodiment, reference may be made to the relevant description in FIG. 2 of the method embodiments, and the same or corresponding technical effects can be achieved. To avoid repetition, details are not described herein again.

For example, the terminal in this embodiment of this application further includes an instruction or a program stored in the memory 809 and executable on the processor 810. The processor 810 invokes the instruction or the program in the memory 809 to perform the method performed by each module shown in FIG. 14, to achieve the same technical effect. To avoid repetition, details are not described herein.

An embodiment of this application further provides a network side device, including a processor and a communication interface. The communication interface is coupled to the processor, and the processor is configured to run a program or an instruction, to implement the steps of the method embodiment shown in FIG. 2 or FIG. 3. The network side device embodiment corresponds to the foregoing method embodiment. The implementation processes and implementations of the foregoing method embodiment are all applicable to the network side device embodiment, and can achieve the same technical effect.

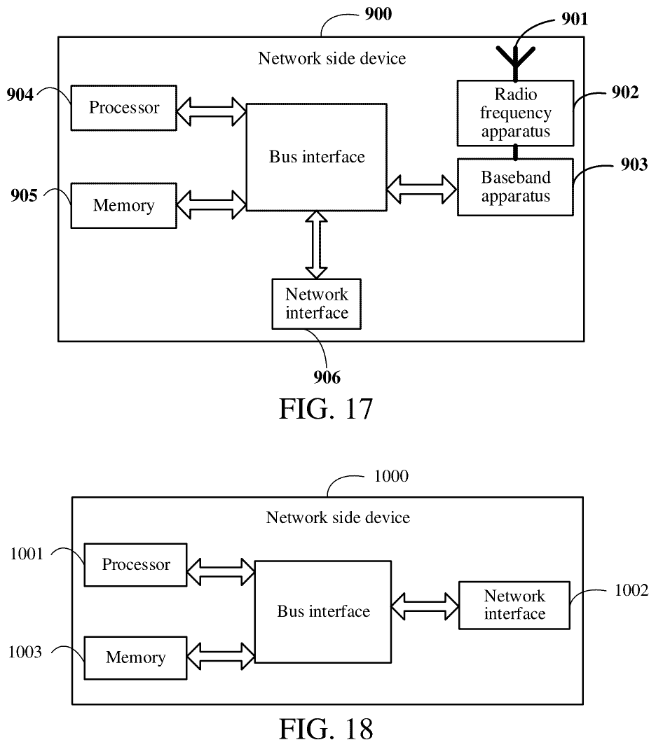

An embodiment of this application further provides a network side device. The network side device may be a master node or a first secondary node. As shown in FIG. 17, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information and sends the processed to-be-sent information to the radio frequency apparatus 902. The radio frequency apparatus 902 processes the received information and then sends the processed received information through the antenna 901.

The method performed by the network side device in the foregoing embodiment may be implemented in the baseband apparatus 903. The baseband apparatus 903 includes a baseband processor.

The baseband apparatus 903 may include, for example, at least one baseband board. A plurality of chips are arranged on the baseband board, as shown in FIG. 17. One of the chips is, for example, the baseband processor, and is connected to the memory 905 through a bus interface to invoke a program in the memory 905 to perform the operations of the network device shown in the foregoing method embodiment.

The network side device may further include a network interface 906. The interface is, for example, a Common Public Radio Interface (CPRI).

For example, the network side device 900 in this embodiment of this application further includes an instruction or a program stored in the memory 905 and executable on the processor 904. The processor 904 invokes the instruction or the program in the memory 905 to perform the method performed by each module shown in FIG. 12 or FIG. 13, and achieves the same technical effect. To avoid repetition, details are not described herein.

An embodiment of this application further provides a network side device. As shown in FIG. 18, the network side device 1000 includes a processor 1001, a network interface 1002, and a memory 1003. The network interface 1002 is, for example, a CPRI.

The network side device 1000 in this embodiment of this application further includes an instruction or a program stored in the memory 1003 and executable on the processor 1001. The processor 1001 invokes the instruction or the program in the memory 1003 to perform the method performed by each module shown in FIG. 12 or FIG. 13, and achieves the same technical effect. To avoid repetition, details are not described herein.

An embodiment of this application further provides a readable storage medium. The readable storage medium stores a program or an instruction. The program or the instruction, when executed by a processor, implements the processes of the foregoing embodiments of the CPC configuration method, and can achieve the same technical effect. To avoid repetition, details are not described herein again.

The processor is a processor in the terminal described in the foregoing embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

An embodiment of this application further provides a chip. The chip includes a processor and a communication interface. The communication interface is coupled to the processor. The processor is configured to run a program or an instruction, to implement the processes of the foregoing embodiments of the CPC configuration method, and can achieve the same technical effect. To avoid repetition, details are not described herein again.

It should be understood that the chip mentioned in this embodiment of this application may further be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing embodiments of the CPC configuration method, and can achieve the same technical effect. To avoid repetition, details are not described herein again.

An embodiment of this application further provides a CPC configuration system, including a master node, a first secondary node, and a terminal. The master node may be configured to perform the steps of the CPC configuration method applied to the master node as described above. The first secondary node may be configured to perform the steps of the CPC configuration method applied to the first secondary node as described above. The terminal may be configured to perform the steps of the CPC configuration method applied to the terminal as described above.

It should be noted that in this specification, terms “include”, “comprise”, or any other variants thereof are intended to encompass non-exclusive inclusion, so that a process, a method, an article, or an apparatus including a series of elements not only includes those elements, but also includes another element not listed explicitly, or includes elements inherent to the process, the method, the article, or the apparatus. Without any further limitation, an element defined by the phrase “include one . . . ” does not exclude existence of an additional same element in the process, the method, the article, or the apparatus that includes the element. In addition, it should be noted that the scope of the method and the apparatus in implementations of this application is not limited to function execution in the order shown or discussed, and may further include function execution in a substantially simultaneous manner or in the opposite order based on the functions involved. For example, the described method may be performed in an order different from the described order, and various steps may further be added, omitted, or combined. Moreover, features described with reference to some examples may be combined in another example.

Through the descriptions of the foregoing implementations, a person skilled in the art may clearly learn that the method in the foregoing embodiments may be implemented by a computer software product with a necessary universal hardware platform, or may be implemented by hardware. The computer software product is stored in a storage medium (such as a ROM, a RAM, a magnetic disk, or an optical disc) and includes several instructions, to enable the terminal or the network side device to perform the method in embodiments of this application.

Although embodiments of this application are described above with reference to the accompanying drawings, this application is not limited to the foregoing implementations. The foregoing implementations are illustrative only but not restrictive. With the enlightenment of this application, a person of ordinary skill in the art may make many forms of implementations without departing from the concept of this application and the protection scope of the claims. These implementations fall within the protection scope of this application.

What is claimed is:

1. A Conditional Primary secondary cell Change (CPC) configuration method, comprising:
receiving, by a master node, first indication information sent by a first secondary node,
wherein:
the first secondary node is a secondary node corresponding to a first target candidate cell,
the first target candidate cell is a target candidate cell for an N^{th} CPC of a terminal,
N is a positive integer, and
the first indication information is used to indicate CPC-related information of an (N+1)^{th} CPC of the terminal when the serving primary secondary cell of the terminal is changed to the first target candidate cell; and
sending, by the master node, a CPC configuration to the terminal based on the CPC-related information of the (N+1)^{th} CPC of the terminal.

2. The CPC configuration method according to claim 1, wherein the CPC-related information of the (N+1)^{th} CPC comprises at least one of the following:
an identifier of a second target candidate cell; or
a CPC execution condition corresponding to the second target candidate cell, wherein
the second target candidate cell is a target candidate cell for the (N+1)^{th} CPC of the terminal when the serving primary secondary cell of the terminal is changed to the first target candidate cell.

3. The CPC configuration method according to claim 1, wherein before the receiving, by a master node, first indication information sent by a first secondary node, the method further comprises:
sending, by the master node, second indication information to the first secondary node, wherein the second indication information is used to indicate at least one of the following:
a subsequent CPC;
the CPC-related information of the (N+1)^{th} CPC of the terminal provided by the first secondary node to the master node when the serving primary secondary cell of the terminal is changed to the first target candidate cell;
the secondary node performing subsequent CPC preparation or non-subsequent CPC preparation; or
an identifier of the first target candidate cell.

4. The CPC configuration method according to claim 3, wherein the receiving, by a master node, first indication information sent by a first secondary node comprises:
receiving, by the master node, the first indication information sent by the first secondary node when the second indication information indicates the subsequent CPC.

5. The CPC configuration method according to claim 2, wherein after the receiving, by a master node, first indication information sent by a first secondary node, the method further comprises:
sending, by the master node, third indication information to a second secondary node, wherein the second secondary node is a secondary node corresponding to the second target candidate cell, and the third indication information is used to indicate at least one of the following:
a subsequent CPC;
CPC-related information of an (N+2)^{th} CPC of the terminal provided by the second secondary node to the master node when the serving primary secondary cell of the terminal is changed to the second target candidate cell; or
the identifier of the second target candidate cell.

6. The CPC configuration method according to claim 1, wherein:
the first indication information is further used to indicate CPC-related information of an (N+2)^{th} CPC of the terminal when the serving primary secondary cell of the terminal is changed to the second target candidate cell, and the second target candidate cell is the target candidate cell for the (N+1)^{th} CPC of the terminal when the serving primary secondary cell of the terminal is changed to the first target candidate cell; and
the sending, by the master node, a CPC configuration to the terminal based on the CPC-related information of the (N+1)^{th} CPC of the terminal comprises:
sending, by the master node, the CPC configuration to the terminal based on the CPC-related information of the (N+1)^{th} CPC of the terminal and the CPC-related information of the (N+2)^{th} CPC.

7. The CPC configuration method according to claim 1, wherein one or more first target candidate cells are arranged;
the CPC-related information of the (N+1)^{th} CPC comprises the identifier of the second target candidate cell corresponding to each of the first target candidate cells; or
the CPC-related information of the (N+1)^{th} CPC comprises a CPC execution condition of the second target candidate cell corresponding to each first target candidate cell.

8. The CPC configuration method according to claim 3, wherein before the sending, by the master node, second indication information to the first secondary node, the method further comprises:
receiving, by the master node, fifth indication information sent by a third secondary node, wherein the third secondary node is a secondary node corresponding to the serving primary secondary cell of the terminal; and
the fifth indication information is used to indicate at least one of the following:
a subsequent CPC;
performing, by the master node, subsequent CPC preparation, or sending, by the master node, the second indication information to the first secondary node to perform the subsequent CPC preparation; or
the identifier of the first target candidate cell.

9. The CPC configuration method according to claim 1, wherein the CPC configuration comprises the CPC-related information of the (N+1)^{th} CPC of the terminal and a source cell for the (N+1)^{th} CPC of the terminal.

10. The CPC configuration method according to claim 9, wherein the CPC-related information of the (N+1)^{th} CPC comprises at least one of the following:
the identifier of the second target candidate cell; or
the CPC execution condition corresponding to the second target candidate cell, wherein
the second target candidate cell is a target candidate cell for the (N+1)^{th} CPC of the terminal when the serving primary secondary cell of the terminal is changed to the first target candidate cell.

11. A Conditional Primary secondary cell Change (CPC) configuration method, comprising:
sending, by a first secondary node, first indication information to a master node,
wherein:
the first secondary node is a secondary node corresponding to a first target candidate cell, the first target candidate cell is a target candidate cell for an N^{th} CPC of a terminal, and N is a positive integer; and
the first indication information is used to indicate CPC-related information of an (N+1)^{th} CPC of the terminal when a serving primary secondary cell of the terminal is changed to the first target candidate cell.

12. The CPC configuration method according to claim 11, wherein the CPC-related information of the (N+1)^{th} CPC comprises at least one of the following:
an identifier of a second target candidate cell; or
a CPC execution condition corresponding to the second target candidate cell, wherein
the second target candidate cell is a target candidate cell for the (N+1)^{th} CPC of the terminal when the serving primary secondary cell of the terminal is changed to the first target candidate cell.

13. The CPC configuration method according to claim 11, wherein before the sending, by a first secondary node, first indication information to a master node, the method comprises:
receiving, by the first secondary node, second indication information sent by the master node, wherein the second indication information is used to indicate at least one of the following:
a subsequent CPC; or
an identifier of the first target candidate cell.

14. The CPC configuration method according to claim 13, wherein before the sending, by a first secondary node, first indication information to a master node, the method further comprises:
sending, by the first secondary node, the first indication information to the master node when the second indication information indicates the subsequent CPC.

15. The CPC configuration method according to claim 11, wherein:
the first indication information is further used to indicate CPC-related information of an (N+2)^{th} CPC of the terminal when the serving primary secondary cell of the terminal is changed to the second target candidate cell; and
the second target candidate cell is a target candidate cell for the (N+1)^{th} CPC of the terminal when the serving primary secondary cell of the terminal is changed to the first target candidate cell.

16. A communication device, comprising: a processor; and a memory, wherein the memory stores a program or an instruction executable in the processor, and the program or the instruction, when executed by the processor, causes the processor to perform operations comprising:
receiving first indication information sent by a first secondary node,
wherein:
the first secondary node is a secondary node corresponding to a first target candidate cell,
the first target candidate cell is a target candidate cell for an N^{th} Conditional Primary secondary cell Change (CPC) of a terminal,
N is a positive integer, and
the first indication information is used to indicate CPC-related information of an (N+1)^{th} CPC of the terminal when the serving primary secondary cell of the terminal is changed to the first target candidate cell; and
sending a CPC configuration to the terminal based on the CPC-related information of the (N+1)^{th} CPC of the terminal.

17. The communication device according to claim 16, wherein the CPC-related information of the (N+1)^{th} CPC comprises at least one of the following:
an identifier of a second target candidate cell; or
a CPC execution condition corresponding to the second target candidate cell, wherein
the second target candidate cell is a target candidate cell for the (N+1)^{th} CPC of the terminal when the serving primary secondary cell of the terminal is changed to the first target candidate cell.

18. The communication device according to claim 16, wherein before the receiving first indication information sent by a first secondary node, the operations further comprise:
sending second indication information to the first secondary node, wherein the second indication information is used to indicate at least one of the following:
a subsequent CPC;
the CPC-related information of the (N+1)^{th} CPC of the terminal provided by the first secondary node to the communication device when the serving primary secondary cell of the terminal is changed to the first target candidate cell;
the secondary node performing subsequent CPC preparation or non-subsequent CPC preparation; or
an identifier of the first target candidate cell.

19. The communication device according to claim 18, wherein the receiving first indication information sent by a first secondary node comprises:
receiving the first indication information sent by the first secondary node when the second indication information indicates the subsequent CPC.

20. The communication device according to claim 17, wherein after the receiving first indication information sent by a first secondary node, the operations further comprise:
sending third indication information to a second secondary node, wherein the second secondary node is a secondary node corresponding to the second target candidate cell, and the third indication information is used to indicate at least one of the following:
a subsequent CPC;
CPC-related information of an (N+2)^{th} CPC of the terminal provided by the second secondary node to the communication device when the serving primary secondary cell of the terminal is changed to the second target candidate cell; or
the identifier of the second target candidate cell.
